(19) United States
(12) Patent Application Publication
(10) Pub. No.: US 2021/0365680 A1
(43) Pub. Date: Nov. 25, 2021

(54) SYSTEMS AND METHODS FOR DETERMINING TRAILER STATUS

(71) Applicant: Schneider Enterprise Resources, LLC, Green Bay, WI (US)

(72) Inventors: Christopher Mossberg, Appleton, WI (US); Justin Sachs, Green Bay, WI (US); Stefanie Abitz-Grun, Green Bay, WI (US)

(73) Assignee: Schneider Enterprise Resources, LLC, Green Bay, WI (US)

(21) Appl. No.: 16/881,834

(22) Filed: May 22, 2020

(51) Int. Cl. G06K 9/00; B60D 1/26; G01C 21/36; H04W 4/029; H04W 4/021

(52) U.S. Cl. CPC G06K 9/00671; B60D 1/26; H04W 4/021; H04W 4/029; G01C 21/3614

(57) ABSTRACT

A system and method include receiving sensor data from a trailer, determining a current status of the trailer based on the sensor data, the current status including a location of the trailer and whether the trailer is empty or loaded, updating the current status of the trailer based upon at least one of an order information or user input, and making the updated status of the trailer available to a user via a user interface.

### BACKGROUND

Various applications depend on timely and accurate information on current location of trailers used in shipping orders of customer goods. However, conventional systems are lacking in providing easy accessibility to tracked information of the location and current status of the trailers.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

In accordance with some embodiments of the present disclosure, a method is disclosed. The method includes receiving sensor data from a trailer, determining a current status of the trailer based on the sensor data, the current status including a location of the trailer and whether the trailer is empty or loaded, updating the current status of the trailer based upon at least one of an order information or user input, and making the updated status of the trailer available to a user via a user interface.

In accordance with further embodiments of the present disclosure, a system is disclosed. The system includes one or more memories having computer-readable instructions stored thereon and one or more processors that execute the computer-readable instructions to receive sensor data from a trailer, determine a current status of the trailer based on the sensor data, such that the current status includes a location of the trailer and whether the trailer is empty or loaded, update the current status of the trailer based upon at least one of an order information or user input, and make the updated status of the trailer available to a user via a user interface.

In accordance with further embodiments of the present disclosure, one or more non-transitory computer-readable storage media having computer-readable instructions stored thereon are disclosed. The computer-readable instructions when executed by a processor of a yard check application cause the processor to receive sensor data from a trailer, determine a current status of the trailer based on the sensor data, such that the current status includes a location of the trailer and whether the trailer is empty or loaded, update the current status of the trailer based upon at least one of an order information or user input, and make the updated status of the trailer available to a user via a user interface.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of a computing system implementing a yard check application, in accordance with some embodiments of the present disclosure.

FIG. 2 is an example block diagram showing additional details of the yard check application of FIG. 1, in accordance with some embodiments of the present disclosure.

FIG. 3 is an example flowchart outlining operations of a process for determining a status of a trailer, in accordance with some embodiments of the present disclosure.

FIG. 4 is an example flowchart outlining operations of a process for updating the determined trailer status of FIG. 3 based on order information, in accordance with some embodiments of the present disclosure.

FIG. 5 is an example flowchart outlining operations of a process for updating the determined trailer status of FIG. 3 based on user input of the trailer status, in accordance with some embodiments of the present disclosure.

FIG. 6 is an example flowchart outlining operations of a process for determining a type of cargo in a trailer, in accordance with some embodiments of the present disclosure.

FIG. 7 is an example flowchart outlining operations of a process for validating a type of cargo in a trailer based on order information, in accordance with some embodiments of the present disclosure.

FIG. 8 is an example flowchart outlining operations of a process for generating information of tracked trailers and tracked cargo, in accordance with some embodiments of the present disclosure.

FIG. 9 is an example user interface of the yard check application of FIG. 1 showing options for criteria to search for trailers located at yards and tracked trailer information, in accordance with some embodiments of the present disclosure.

FIG. 10 is an example user interface of the yard check application of FIG. 1 showing options to search for trailers located at yards based on a current status of the trailers, in accordance with some embodiments of the present disclosure.

FIG. 11 is an example user interface of the yard check application of FIG. 1 showing options to search for trailers located at yards based on a current city/state location of the trailers, in accordance with some embodiments of the present disclosure.

FIG. 12 is an example user interface of the yard check application of FIG. 1 showing options to search for trailers located at yards based on a current site location of the trailers, in accordance with some embodiments of the present disclosure.

FIG. 13 is an example user interface of the yard check application of FIG. 1 showing a table of tracked trailer information, in accordance with some embodiments of the present disclosure.

FIG. 14 is an example user interface of the yard check application of FIG. 1 showing an interactive map of tracked trailers at one or more yards, in accordance with some embodiments of the present disclosure.

FIG. 15 is an example user interface of the yard check application of FIG. 1 showing a more detailed view of an interactive map of a tracked trailer within a yard, in accordance with some embodiments of the present disclosure.

FIG. 16 is an example user interface of the yard check application of FIG. 1 showing options to search for tracked shipments transported by the trailers, in accordance with some embodiments of the present disclosure.

FIG. 17 is an example user interface of the yard check application of FIG. 1 showing detailed tracking information of a shipment order, in accordance with some embodiments of the present disclosure.

FIG. 18 is an example user interface of the yard check application of FIG. 1 showing options to view and retrieve shipment documents, in accordance with some embodiments of the present disclosure.

FIG. 19 is an example user interface of the yard check application of FIG. 1 showing a generated email push notification for providing information on tracked shipments based on whether the shipments are on-schedule for delivery, in accordance with some embodiments of the present disclosure.

FIG. 20 is an example user interface of the yard check application of FIG. 1 showing options to anonymously view tracked shipment orders, in accordance with some embodiments of the present disclosure.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

A shipping yard, which also may be referred to as a container yard, a container port, a shipping terminal, etc., is a location where a trailer used for transporting cargo may be temporarily stored. In some embodiments, the trailers may be temporarily stopped at a shipping yard to unload and/or load cargo during a delivery route with several delivery locations. In some embodiments, the trailers may be temporarily stored at a shipping yard when the trailers are not currently in use. Additionally, trailers may stop or be stored at a shipping yard when maintenance is required for the trailer. In other embodiments, trailers may stop at a shipping yard when scheduled delivery routes and estimated delivery times for shipments change due to inclement weather, heavy traffic, road accidents, etc. For example, due to dangerous road conditions from an unexpected snowstorm, a trailer may stop at a shipping yard and load additional cargo for a new delivery route with a prioritized shipment.

Existing systems of tracking trailers and cargo orders are limited in the ability to provide easy and quick access to view locations and status of the trailers and cargo within shipping yards. Delays in providing this information may cause an increase in likelihood that shipments are delayed. Additionally, delays in providing this information may cause loading/unloading processes of cargo from trailers within the shipping yards to be longer and less efficient. For example, once a notification is received that a trailer has arrived at a shipping yard with a delivery of cargo at a customer site, a user may spend an unnecessary amount of time tracking down the location of the correct trailer within the shipping yard with the correct cargo to be unloaded. Furthermore, current systems are lacking in searching and filtering numerous tracked locations of trailers within one or more shipping yards based on criteria entered by a user. Thus, improving the ability to monitor the trailer status and locations of tracked trailers and cargo within shipping yards may greatly save companies time and other resources in planning shipments and trailer allocation, loading trailers with cargo, unloading trailers, and so on by having real-time monitoring of the trailer and cargo status and locations.

The present disclosure provides systems to track locations and/or status of trailers within shipping yards, according to various example embodiments. Various embodiments provide for tracking of trailer location and/or status within shipping yards across several geographic locations (e.g., cities) and customer sites. In some embodiments, in a delivery route with various stops at shipping yards of customer sites, improving the accuracy of determining the current location of the trailer and a current status of the trailer within shipping yards, such as empty, outbound loaded, or inbound loaded, may be advantageous. Beneficially, companies may vastly improve efficiency with the ability to easily and quickly view trailer locations and the status of the trailers within shipping yards. In addition, the present disclosure presents mechanisms to track freight status, including information on each stop location (e.g., at a shipping yard) on a delivery route, a detailed, interactive map of the delivery route for the freight, and a capability to quickly export the data. As such, the present disclosure may improve accessibility to viewing information on shipments at risk of being late and/or shipments that are currently on-schedule to be delivered on time. By improving notifications of potentially delayed orders, the present disclosure may provide mechanisms that can overall improve customer relations and customer service by proactively notifying users of deliveries that are at risk of being late.

Particularly, the present disclosure provides a yard check application including a yard check engine configured to determine trailer status information and search for trailers within shipping yards that are tracked by the yard check application based on trailer status information. In some embodiments, the yard check engine is also configured to track a current location of the trailers and generate an interactive map indicating the location of each of the trailers within one or more shipping yards. The yard check engine may also be configured to filter the interactive map based on trailer status of the trailers displayed on the map. The yard check engine may be configured to display trailer status data and trailer location data in response to a selection of an icon on the interactive map of one of the trailers. Furthermore, the yard check engine may color-code the icons of the trailer locations based on the trailer status of the trailer for each of the trailer locations within one or more shipping yards. In some embodiments, the yard check engine may use cargo information received from an order system to validate a trailer status determined based on sensor data. Additionally, the yard check engine may be configured to validate a trailer status determined based on sensor data with user input of the trailer status received via a user interface of the yard check application. In some embodiments, the yard check engine may also monitor the status of cargo for shipping orders and determine a type of cargo in a trailer within a shipping yard based on image data of the inside of the trailer.

As discussed herein, a shipping yard is referred to as a “yard.” While the present disclosure discusses freight moved in trailers, it is to be understood that the present disclosure may be used with respect to containers or other types of storage boxes, vans, wagons, and the like. Furthermore, the present disclosure may also be applicable with respect to any kind of transportation vehicles, including train, air (planes/helicopters), intermodal (combination of transportation modes, such as truck and train), etc. In the present disclosure, the terms “load,” “freight,” “cargo,” and “shipment” may be used synonymously/interchangeably to describe goods transported in the trailers.

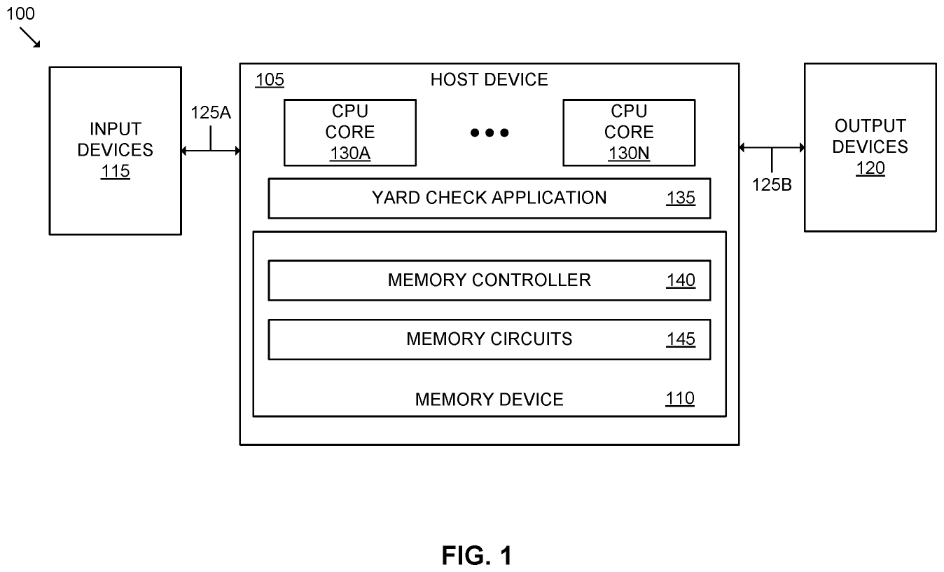

Referring now to FIG. 1, an example block diagram of a computing system 100 is shown, in accordance with some embodiments of the present disclosure. The computing system 100 includes a host device 105. The host device 105 includes a memory device 110. In other embodiments, the memory device 110 associated with the host device 105 is a separate device that is communicatively coupled to the host device 105 instead. The host device 105 may be configured to receive input from one or more input devices 115 and provide output to one or more output devices 120. The host device 105 may be configured to communicate with the input devices 115 and the output devices 120 via appropriate interfaces or channels 125A and 125B, respectively. The computing system 100 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 105.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 100) may be implemented by multiple computing devices in a distributed environment, and vice versa. In some embodiments, the computing system 100 or at least some of the features described herein may be implemented in an in-vehicle system (e.g., tablet) that may be configured to perform at least some of the trailer and cargo status computations described herein and report those out to a server while, in other embodiments, the server may perform the calculations (e.g., using past tracked cargo and/or trailer data and/or other data obtained from the in-vehicle system and/or other systems).

The input devices 115 may include any of a variety of input technologies such as a keyboard, stylus, touch screen, mouse, track ball, keypad, microphone, voice recognition, motion recognition, remote controllers, input ports, one or more buttons, dials, joysticks, camera, and any other input peripheral that is associated with the host device 105 and that allows an external source, such as a user, to enter information (e.g., data) into the host device and send instructions to the host device 105. Similarly, the output devices 120 may include a variety of output technologies such as external memories, printers, speakers, displays, microphones, light emitting diodes, headphones, plotters, speech generating devices, video devices, global positioning systems, and any other output peripherals that are configured to receive information (e.g., data) from the host device 105. The “data” that is either input into the host device 105 and/or output from the host device may include any of a variety of textual data, graphical data, video data, image data, sound data, position data, sensor data, combinations thereof, or other types of analog and/or digital data that is suitable for processing using the computing system 100.

The host device 105 may include one or more Central Processing Unit (“CPU”) cores or processors 130A-130N that may be configured to execute instructions for running one or more applications associated with the host device 105. In some embodiments, the instructions and data needed to run the one or more applications may be stored within the memory device 110. The host device 105 may also be configured to store the results of running the one or more applications within the memory device 110. One such application on the host device 105 may include a yard check application 135. The yard check application 135 may be executed by one or more of the CPU cores 130A-130N. The instructions to execute the yard check application 135 may be stored within the memory device 110. The yard check application 135 is described in greater detail below. Thus, the host device 105 may be configured to request the memory device 110 to perform a variety of operations. For example, the host device 105 may request the memory device 110 to read data, write data, update or delete data, and/or perform management or other operations.

To facilitate communication with the memory device 110, the memory device 110 may include or be associated with a memory controller 140. Although the memory controller 140 is shown as being part of the memory device 110, in some embodiments, the memory controller 140 may instead be part of another element of the computing system 100 and operatively associated with the memory device 110. For example, when the memory device 110 is a separate device from the host device 105, the memory controller 140 may be configured as a logical block or circuitry that receives instructions from the host device 105 and performs operations in accordance with those instructions. For example, when the execution of the yard check application 135 is desired, the host device 105 may send a request to the memory controller 140. The memory controller 140 may read the instructions associated with the yard check application 135 that are stored within the memory device 110, and send those instructions back to the host device 105. Continuing with the example embodiment of the memory device 110 being a separate device from the host device 105, those instructions may be temporarily stored within a memory on the host device 105. One or more of the CPU cores 130A-130N may then execute those instructions by performing one or more operations called for by those instructions of the yard check application 135.

The memory device 110 may include one or more memory circuits 145 that store data and instructions. The memory circuits 145 may be any of a variety of memory types, including a variety of volatile memories, non-volatile memories, or a combination thereof. For example, in some embodiments, one or more of the memory circuits 145 or portions thereof may include NAND flash memory cores. In other embodiments, one or more of the memory circuits 145 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 110. In some embodiments, one or more of the memory circuits 145 or portions thereof may be configured as other types of storage class memory (“SCM”). Generally speaking, the memory circuits 145 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 100 are shown and described in FIG. 1. However, the computing system 100 may include other components such as various batteries and power sources, networking interfaces, routers, switches, external memory systems, controllers, etc. Generally speaking, the computing system 100 may include any of a variety of hardware, software, and/or firmware components that are needed or considered desirable in performing the functions described herein. Similarly, the host device 105, the input devices 115, the output devices 120, and the memory device 110, including the memory controller 140 and the memory circuits 145, may include hardware, software, and/or firmware components that are considered necessary or desirable in performing the functions described herein. In addition, in certain embodiments, the memory device 110 may integrate some or all of the components of the host device 105, including, for example, the CPU cores 130A-130N, and the CPU cores may be configured to execute the yard check application 135, as described herein.

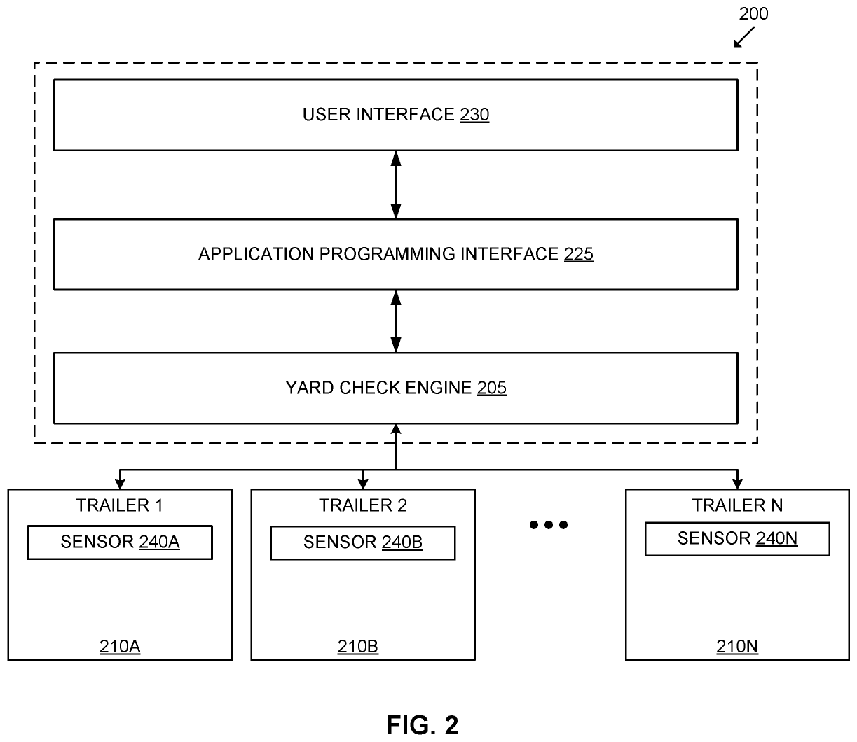

Turning now to FIG. 2, an example yard check application 200 is shown, in accordance with some embodiments of the present disclosure. The yard check application 200 is an example implementation of the yard check application 135 of FIG. 1. Thus, although not shown, the yard check application 200 may be associated with a host device (e.g., the host device 105) and other elements described above in FIG. 1. The yard check application 200 may be used to track location and/or status of one or more trailers via a yard check engine 205 that receives data from one or more trailers 210A-210N (collectively referred to herein as “trailers 210”)). Although not shown, the yard check engine 205 may include or be associated with other types of software, hardware, firmware, or combinations thereof that may be needed or considered desirable to have for performing the functions described herein.

The yard check application 200 may also include a user interface 230 that serves as the front end of the yard check application. In some embodiments, the yard check engine 205 may be accessed through the user interface 230 via an Application Programming Interface (“API”) 225. Specifically, to access the yard check engine 205 via the user interface 230 using the API 225, a user may use designated devices such as laptops, desktops, tablets, mobile devices, other handheld or portable devices, and/or other types of computing devices that are configured to access the API 225. In some embodiments, these devices may be different from the computing device on which the yard check application 200 is installed. In other embodiments, the yard check application 200 may be hosted on a cloud service and may be accessed through the cloud via a web or mobile application.

In some embodiments, the user may access the user interface 230/the yard check engine 205 via a web browser, upon entering a uniform resource locator (“URL”) for the API 225 such as the IP address of the yard check application 200 or other designated web address. In some embodiments, the user interface 230/the yard check engine 205 may be accessed via a mobile application downloaded to a mobile device. In other embodiments, the user interface 230/the yard check engine 205 may be configured for access in other ways. In some embodiments, a user of the yard check application 200 may be a provider of the yard check application or any personnel/entity to whom the provider makes the yard check application accessible. For example, in some embodiments, the user may be a provider of trailers, containers, or other storage equipment that may be used to ship cargo from one point to another. In other embodiments, the user may be a customer that uses those trailers, containers, etc. for shipment of their cargo. Generally speaking, the user of the yard check application 200 may be any personnel, company, or entity that may be interested at least in the status updates, cargo type, and/or location of the trailers 210. It is to be understood that, while the present disclosure has been described with respect to trailers 210 and cargo on the trailers 210, the present disclosure may also be applicable to other applications where real-time and accurate monitoring of a status of a vehicle delivering a shipment and the shipment itself, is desired.

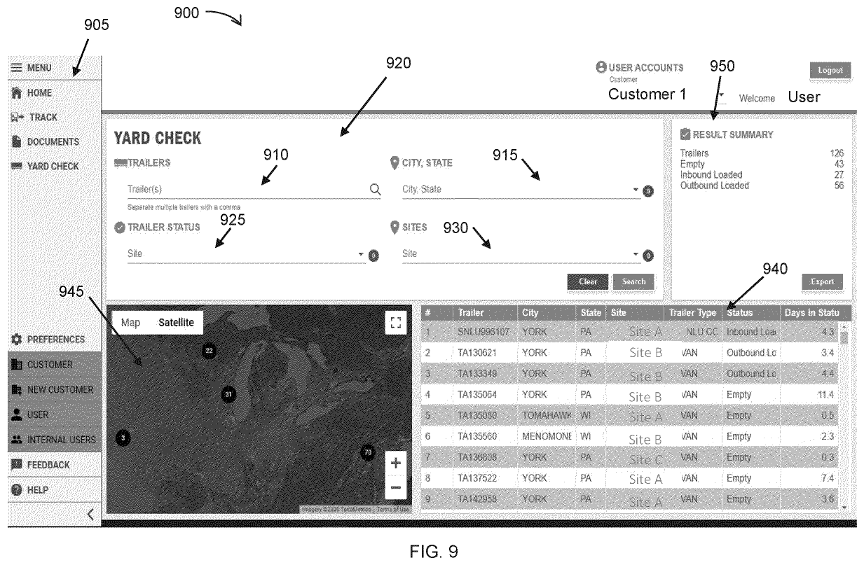

Further, upon accessing the user interface 230/the yard check engine 205, users may send instructions or queries to the yard check engine 205 and receive information back from the yard check engine via the user interface 230. Thus, the user interface 230 facilitates human-computer interaction between the users and the yard check engine 205. In some embodiments, the user interface 230 may present a graphical user interface (“GUI”) to a user to receive input from and provide output to the user. The GUI may present a variety of graphical icons, windows, visual indicators, menus, visual widgets, and other indicia to facilitate user interaction. Example user interfaces 230 of the yard check application 200 are shown in FIGS. 9-20 and described further below. In other embodiments, the user interface 230 may be configured as other types of user interfaces. Further, the user interface 230 may be configured to receive user inputs in a variety of ways. In some embodiments, the user interface 230 may be configured to receive user inputs via the input devices 115. In other embodiments, the user interface 230 may be configured to receive the user inputs in other ways. The user interface 230 may also be configured to present outputs/information to the users in a variety of ways. In some embodiments, the user interface 230 may present outputs to the user via the output devices 120. In other embodiments, the user interface 230 may be configured to present the outputs in other ways (e.g., audible, tactile, or visual alarms, etc.). Generally speaking, the user interface 230 may be associated with any type of hardware, software, and/or firmware component that enables the yard check application 200 to perform the functions described herein.

Further, in some embodiments, the API 225 that is used to communicate with the yard check engine 205 via the user interface 230 may be a representational state transfer (“REST”) type of API. In other embodiments, the API 225 may be any other type of web or other type of API (e.g., ASP.NET) built using any of a variety of technologies, such as Java, .Net, etc., that is suitable for facilitating communication between the yard check engine 205 and the users via the user interface 230. In some embodiments, the API 225 may be configured to facilitate communication via a hypertext transfer protocol (“HTTP”) or hypertext transfer protocol secure (“HTTPS”) type request. The API 225 may receive an HTTP/HTTPS request and send an HTTP/HTTPS response back. In other embodiments, the API 225 may be configured to facilitate communication using other or additional types of communication protocols.

It is to be understood that only some components of the yard check application 200 are shown and described in FIG. 2. However, the yard check application 200 may include or be associated with any of a variety of hardware, software, and/or firmware components that are needed or considered desirable in performing the functions described herein.

Referring still to FIG. 2 and as indicated above, the yard check engine 205 receives input from the trailers 210. In some embodiments, each of the trailers 210 may be a storage container or other types of nonautomotive wagon, box, or the like configured to be attached to a transportation vehicle for hauling cargo or freight from one destination to another. The shape, size, and other configuration details of each of the trailers 210 may vary from one embodiment to another. Further, the type of transportation vehicle to which the trailers 210 are attached may vary from one embodiment to another. For example, in some embodiments, the trailers 210 may be configured for transportation by road or rail. In other embodiments, the trailers 210 may additionally or alternatively be configured for transportation by water, air, or any other suitable modes of transportation. In some embodiments, the trailers 210 may be configured for transportation by a single mode of transportation. In other embodiments, the trailers 210 may be configured for intermodal transportation. Further, in some embodiments, each of the trailers 210 may be associated with a trailer type, a trailer location, a customer site location, a trailer identifier (e.g., a trailer identifier number and/or keyword), a trailer status, and/or any other information that may be considered necessary or desirable to have in identifying a trailer, the location and status of that trailer, the cargo that is carried or intended to be carried within that trailer, etc.

Additionally, in some embodiments, the trailers 210 may be located on a yard (e.g., of a customer) in between travel or for loading, maintenance, etc., or en-route, either outbound or inbound. As described herein, a “yard” may refer to any area or site where a trailer may be parked for cargo loading and/or unloading, maintenance, or generally between travel. In some embodiments, each yard may be associated with a geo-fence area, described in greater detail below. In some embodiments, the geo-fence area of the yard may be provided as an input (e.g., as location coordinates (e.g., latitude and longitude coordinates)) to the yard check application 200. In some embodiments, the trailers 210 may all be located on a single site. In other embodiments, the trailers 210 may be spread across multiple yard sites.

Further, in some embodiments, each of the trailers 210 is equipped with one or more sensors. For example and as shown in FIG. 2, in some embodiments, the trailer 210A may be equipped with a sensor 240A, the trailer 210B may be equipped with a sensor 240B, and so on. Although each of the trailers 210 is shown as having a single sensor, in other embodiments, one or more of those trailers may have multiple sensors. Further, the type of sensor or sensors on each of the trailers 210 may vary from one embodiment to another. For example, in some embodiments, one or more of the sensors 240A-240N (collectively referred to herein as “sensors 240”) may include temperature sensors, audio sensors, pressure sensors, inertial sensors such as accelerometers, light detection and illumination sensors, motion sensors, proximity sensors such as inductive, capacitive, ultrasonic, or photoelectric sensors, location sensors such as global positioning system (GPS) sensors, camera systems, video camera systems, lighting systems, and/or any other type of sensor(s) that may be used to determine the status and/or location of a trailer, the type of cargo within a trailer, and any other information that is desirable to collect from the trailers 210. The data collected by the sensors 240 may be utilized by the yard check engine 205 to determine a location and/or status of the trailers 210, as discussed in greater detail below. The sensors 240 may also be used to determine a type of cargo stored within the trailers 210.

Additionally, the location of the sensors 240 on the trailers 210 may vary from one embodiment to another. In some embodiments, the sensors 240 may be installed in the interior of the trailers 210 to generate sensor data regarding the inside of those trailers. For example, one or more cameras may be installed on the interior of the trailers 210 to take images of any cargo stored within those trailers. The cameras installed on the interior of the trailers 210 may also be used to determine whether the trailers are empty or loaded. Similarly, in some embodiments, other types of sensors may be installed on the interior of the trailers 210 to gather desired information from the interior of those trailers. In other embodiments, the sensors 240 may additionally or alternatively be installed on the exterior of the trailers 210. For example, cameras may be installed on the outside of the trailers 210 to collect image data of the areas surrounding the trailers. GPS sensors may also be installed on the exterior of the trailers 210. The location where the sensors 240 are installed on the interior and/or the exterior of the trailers 210 may vary from one embodiment to another. In some embodiments, the trailers 210, including the sensors 240, may form part of an internet of things (IoT) network that communicates data with the yard check engine 205 to monitor the trailers.

The sensors 240 may be configured to collect sensor data from the trailers 210 to which those sensors are mounted to. In some embodiments, the sensors 240 may be configured to collect sensor data continuously, while in other embodiments, the sensors 240 may be configured to collect data periodically. In some embodiments, the sensors 240 may be configured to store temporarily upon collection and/or transmit data periodically. In other embodiments, the sensors 240 may be configured to transmit the collected sensor data instantaneously or substantially instantaneously. Further, in some embodiments, the sensors 240 may be configured to communicate (e.g., to transmit the collected sensor data, to receive instructions, updates, etc. from the yard check engine 205, etc.) with the yard check engine 205 through one or more gateways or other suitable mechanisms. In some embodiments, one or more of the sensors 240 may also be configured to communicate with other sensors on the same trailer and/or with the sensors on other trailers 210. In some embodiments, the sensors 240 may be configured to communicate with other or additional components of the yard check application 200.

Additionally, in some embodiments, the sensors 240 may be configured to communicate (either with the yard check engine 205, other sensors, or any other component with which the sensors communicate with) using communication links including wired and/or wireless communication links such as jacks, antennas, transmitters, receivers, transceivers, wire terminals, electrical cables, connectors, network interfaces, switches, routers, etc. using communication protocols and channels such as TCP/INPUT, BACnet INPUT, BACnet MSTP, CAN Modbus, USB, Firewire, UART, SPI, RS-485, PSTN, Wi-Max, Bluetooth, LoRa, NFC, Zigbee, cellular or mobile phone communication channels (e.g., cellular 5G), wireless radio channels, local area network, metropolitan area network, wide area network, world wide web, internet, Ethernet, etc.

The yard check engine 205, upon receiving the sensor data, may store the sensor data from sensors 240 within memory (e.g., memory device 110). In some embodiments, the yard check engine 205 may be configured to store the sensor data indefinitely, while in other embodiments, the yard check engine may store the sensor data for a designated period of time before deleting that data. As discussed below, the yard check engine 205 may then utilize the sensor data to determine a location of the trailers 210, a status of the trailers, a type of cargo stored in the trailers, etc.

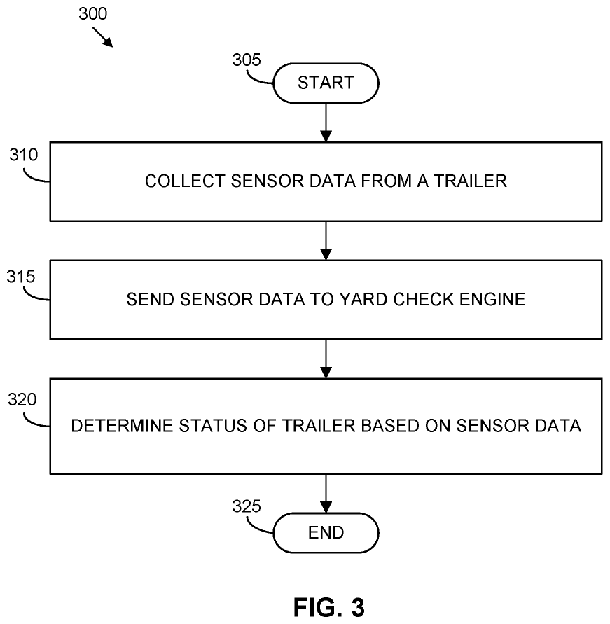

Referring now to FIG. 3, a flowchart outlining operations of a process 300 is shown, in accordance with some embodiments of the present disclosure. In some embodiments, the process 300 is implemented via the yard check engine 205 of the yard check application 200. The process 300 may be utilized in order to determine the status of the trailers 210 based on sensor data collected by the sensors 240. In some embodiments, the process 300 may be used to determine the status of the trailers 210 based on a geo-fenced area. A geo-fence may be a virtual boundary defining a geographic area. In some embodiments, the geo-fenced area may be dynamically generated. For example, the geo-fenced area may be a predetermined radius around a coordinate location, such as a location coordinate of the center of a yard. In other embodiments, the geo-fenced area may be a predetermined boundary that is provided to the yard check application 200, such as a map of a yard indicating a boundary to use as the geo-fence. In some embodiments, a geo-fenced area may include a site of a customer, a yard of a customer, a parking stall in a yard, etc. For example, in some embodiments, for a geo-fenced yard, a first geo-fence may be defined for the main or outer boundary of the yard. Further, in some embodiments, a second geo-fence may be defined for various portions of the yard. As an example, the yard may include one or more stalls or areas where a particular one of the trailers 210 may be parked for various purposes. Each of those stalls or areas may be defined by its own geo-fence. In some embodiments, the geo-fence may span across multiple sites across a single state or even multiple states. By utilizing the geo-fence of specific yard(s), the yard check application 200 may provide locations of trailers 210 based on GPS data from sensors 240 and/or cell phone triangulation from an IoT device on the trailers 210 in both a map and a table format on a user interface, for example.

Further, the term “status” as used herein describes current conditions of the trailers 210. For example, the “status” may include whether the trailer is inbound or outbound, whether the trailer is empty or loaded, whether the trailer is located on a yard or en-route, location of the trailer on the yard, location of the trailer en-route, and so on. A trailer may have a status as “inbound loaded” if that trailer has arrived at the yard with loaded cargo for delivery at that yard. A trailer may have a status of “outbound loaded” if that trailer is currently on the yard, loaded, and ready to depart the yard. As such, a trailer may have a status as “inbound” if the trailer has arrived at the yard, and may have a status as “outbound” if the trailer has been designated to depart from the yard. Additionally, a trailer may have a status as “loaded” if that trailer is carrying at least some cargo, and may have a status as “empty” if that trailer is not carrying any cargo.

The determination of the statuses of the trailers 210 and updates to the statuses may happen in real-time or substantially real-time, in some implementations. Beneficially, the process 300 may allow a user to view the statuses of the trailers 210 via the user interface 230 of the yard check application 200. The process 300 starts at operation 305 to determine the status of one or more of the trailers 210. In some embodiments, the process 300 may be configured to determine the status automatically, while in other embodiments, the process may be configured to determine the status on-demand. When determining the status of the trailers 210 automatically, in some embodiments, the process 300 may be used to determine the status upon satisfaction of certain desired conditions. For example, in some embodiments, the process 300 may be executed upon the passing of a designated amount of time (e.g., every hour, every few hours, every few minutes, seconds, etc.). In other embodiments, the process 300 may be executed at designated times during the day. Further, the process 300 may be executed instantaneously (or substantially instantaneously) upon receiving sensor data from the sensors 240, or upon satisfaction of other predefined conditions. Further, in some embodiments, upon determining or updating the status, the yard check engine 205 may generate an email push notification or report with the current status for sending to a customer or other interested third parties. Thus, the yard check engine 205 allows a customer to manage their trailers more efficiently to save resources and reduce cost of using the trailers to deliver shipments.

At operation 310, the yard check application 200, and particularly the yard check engine 205, collects sensor data from the sensors 240. For purposes of explanation below, the process 300 is described with respect to determining the status of the trailer 210A having the sensor 240A. However, the process 300 is equally applicable to the other trailers 210B-210N. The sensor data that is collected from the sensor 240A may include data about the condition that the sensor is configured to detect (e.g., temperature, location, etc.), information on the time the data was collected/generated, a tag identifying the trailer 210A from which the data is collected, any identification or tag to identify the sensor that collected the data and the location of that sensor, and any other information that is considered necessary or desirable. In some embodiments, the sensor data may also be tagged with an approximate location (e.g., longitude and latitude/GPS coordinates, customer site, city/state, etc.) of the trailer 210A. As such, upon receiving the sensor data, the yard check application 200 may be able to associate the sensor data to the trailer (e.g., the trailer 210A) from which the data is collected and the location of the trailer.

At the operation 315, the collected sensor data is sent to the yard check engine 205. The collected sensor data may be transmitted to the yard check engine 205 continuously or at a predetermined frequency. For example, the sensor data collected at the operation 310 may be transmitted to the yard check engine 205 after a predetermined time interval, such as a minute, five minutes, an hour, a day, etc. The frequency of collecting and transmitting the sensor data to the yard check engine 205 may be input to the yard check application 200 via the input devices 115. In other embodiments, the operation 315 may occur after a qualifying condition is met. For example, if a change in the sensor data is above or below a threshold, the collected sensor data may be sent to the yard check engine 205. In another example, a qualifying condition may include that a user input has been received via a user interface of the yard check application 200 to update a status of the trailer 210A. As yet another example, a qualifying condition may include that the trailer 210A is scheduled to depart for a route within a predetermined time interval. As such, a manager of the trailer 210A may desire an update of the status of the trailer to ensure that the trailer is ready for departure on-time. Upon receiving the sensor data, the yard check engine 205 may store the sensor data within memory (e.g., memory device 110).

The yard check engine 205 determines a status of the trailer 210A based on the sensor data at operation 320. In some embodiments, the yard check engine 205 may determine the status of the trailer 210A by analyzing the sensor data using machine learning or artificial intelligence algorithms, described in greater detail below. In other embodiments, the yard check engine 205 may use image processing techniques to compare sensor data (e.g., an image from an infrared camera, an image from an external camera mounted on a nearby building, etc.) to a baseline image of the trailer 210A. In yet other embodiments, the yard check engine 205 may use a combination of machine learning/artificial intelligence algorithms and image processing to determine the status of the trailer 210A.

In some embodiments, machine learning/artificial intelligence algorithms may use work assignment data received from a transportation management system to further determine the status of the trailer 210A. For example, the yard check engine 205 may analyze work assignment data from a transportation management system, using machine learning, to determine whether trailer 210A has been assigned for loading, unloading, pick-up, and/or drop-off at a yard. In some embodiments, the yard check engine 205 may use other or additional mechanisms to determine the status of trailer 210A.

For example, in some embodiments, the yard check engine 205 may determine whether the trailer 210A is situated on a yard or outside of the yard by comparing the current location of the trailer 210A, from GPS sensor data received at the operation 315, to the location of a geo-fence of the yard. For example, if the location sensor data received from the sensor 240A at the operation 315 indicates that the location of the trailer 210A is determined to be outside the boundary of the yard geo-fence, the yard check engine 205 may determine that the trailer 210A is positioned outside of the yard. In some embodiments, the yard check engine 205 may determine that the trailer 210A is located on the yard by receiving a scan of a radio frequency identification (RFID) tag on the trailer 210A or another kind of tag, such as a Bluetooth tag. In some embodiments, the yard check engine 205 may detect that the trailer 210A is situated on the yard by receiving a transmitted beacon from another type of communication device associated with the trailer 210A. In other embodiments, the yard check engine 205 may determine whether the trailer 210A is situated on the yard by comparing image data from a camera coupled to the outside of the trailer 210A to a baseline image of the yard and/or a parking stall of the yard. For example, a parking stall in a yard may include a sign or parking number for each of the trailers 210 that may be parked in the yard. Thus, the yard check engine 205 may scan image data from a camera associated with trailer 210A to determine whether a sign, parking number, or other flag for a stall is present in the image data.

In some embodiments, the yard check engine 205 determines whether the trailer 210 is located at the yard by receiving and analyzing image data from one or more external cameras located on the yard and/or receiving manual input during a yard check, as described in greater detail below. For example, the yard check engine 205 may receive image data from an external camera mounted on a building within the yard. In another example, the yard check engine 205 may receive image data to identify the location of the trailer 210A on the yard from an external camera mounted on a drone or on another type of vehicle situated at the yard.

In some embodiments, if the trailer 210A is situated outside the yard, the yard check engine 205 may identify the exact location of the trailer 210A by using data from a GPS sensor (e.g., the sensor 240A) positioned on the trailer. In other embodiments, the yard check engine 205 may identify the exact location of the trailer 210A outside of the yard by utilizing third party location data. In other embodiments, if the trailer 210A is situated inside the yard, the yard check engine 205 may identify the exact location of the trailer 210A on the yard by comparing current longitude and latitude data from a sensor 240A to a location coordinated map of the yard. As such, the yard check engine 205 may determine a parking stall associated with the longitude and latitude values from the sensor data. In other embodiments, the yard check engine 205 may identify a precise location of the trailer 210 on the yard by analyzing image data from a camera mounted to the trailer 210A, or from an external camera mounted on a building or other yard vehicle, to extract a parking spot identification number (or other identification information) associated with a stall on the yard. In yet additional embodiments, the yard check engine 200 may determine an exact location of the trailer 210A using proximity sensor data, such as radio frequency identification tags.

In some embodiments, the yard check engine 205 may determine whether the trailer 210A is empty or full by reviewing the sensor data and/or by comparing image data from a camera within the trailer 210A with image data from a baseline image, for example, of cargo and/or the trailer 210A when empty. The yard check engine 205 may utilize machine learning/artificial intelligence, image processing, etc., to determine whether there is a discrepancy between the baseline image and current, collected sensor data of an image of the inside of the trailer 210A. In response to detecting a difference above a set threshold between the sets of image data, the yard check engine 205 may determine that the trailer 210A is full (i.e., loaded with cargo). In other embodiments, the yard check engine 205 may determine whether the trailer 210A is empty or loaded by analyzing sensor data from proximity and/or pressure sensors within the trailer 210A. For example, trailer 210A may have a sensor 240 installed on the floor of the cargo area of the trailer 210A. In response to pressure sensor data indicating a certain amount of pressure, the yard check engine 205 may determine that the trailer 210A is not empty (i.e., is loaded with cargo). In other embodiments, the yard check engine 205 may use other mechanisms to determine whether the trailer 210A is empty or loaded. When the yard check engine 205 determines that the trailer 210A is not empty, the yard check engine may also determine the type of cargo loaded into that trailer, as discussed further below.

In some embodiments, the yard check engine 205 may determine whether the trailer 210A, whether inbound or outbound, is loaded or empty by analyzing data from the sensor 240A and a lighting system installed within the trailer 210A. For example, if the lighting system shines light on the cargo area and the sensor 240 detects a lower amount of light than a baseline amount, the yard check engine 205 determines that the trailer 210A is loaded because cargo is blocking some of the light that normally is received by the sensor 240 when the trailer 210A is empty.

In some embodiments, the yard check engine 205 may determine whether the trailer 210A is inbound or outbound by comparing the direction of the trailers 210A-210N on a route to delivery route information. As such, the yard check engine 205 may determine whether the trailer 210A is outbound or inbound to or from a site. In some embodiments, the yard check engine 205 may determine whether the trailer 210A is inbound or outbound by comparing most recent location data of the trailer 210 to historical location data of the trailer 210A, along with sensor data from an inertial sensor, such as an accelerometer. For example, the yard check engine 205 may compare current location data of the trailer 210A to saved location data from a sensor 240 with a timestamp earlier than the current time. As such, the yard check engine 205 may determine that the trailer 210A is no longer positioned within the geo-fence area of the yard based on the location data, and therefore determines that the trailer 210A is outbound. In some embodiments, the yard check engine 205 may determine whether the trailer 210A is inbound or outbound by using location sensor data to measure whether the distance from the geo-fence of the yard is increasing or decreasing. In response to determining the distance between the current position of the trailer 210A and the geo-fence of the yard is increasing, the yard check engine 205 may determine that the trailer 210A has a current status of outbound. On the other hand, in response to determining the distance between the current position of the trailer 210A and the geo-fence of the yard is decreasing, the yard check engine 205 may determine that the trailer 210A has a current status of inbound. The yard check engine 205 may use other mechanisms to determine whether the trailer 210A is inbound or outbound.

Thus, the yard check engine 205 may analyze current sensor data, previous or old sensor data, third party information, and/or any other relevant information to determine the current status of a trailer (e.g., the trailer 210A). The process 300 ends at operation 325. By determining the status of the trailer 210A, the yard check engine 205 may monitor the trailer information to track change in status of the trailers 210 to improve proper allocation of the trailers and track ongoing shipment orders to determine whether shipments are on-time or at risk of being late, for example.

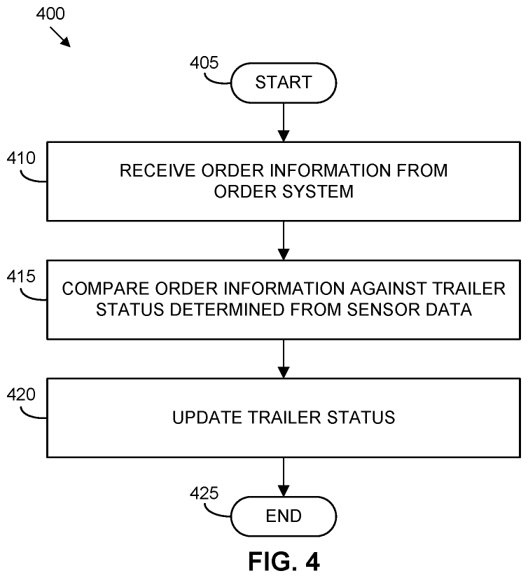

Turning now to FIG. 4, a flowchart outlining operations of a process 400 is shown, in accordance with some embodiments of the present disclosure. In some embodiments, the process 400 may be executed by the yard check engine 205 of the yard check application 200. In some embodiments, the process 400 may be executed after the operation 320 of FIG. 3. The process 400 may be used to update the status of the trailer 210A based on order information received from an order system of a customer. Again, the process 400 is explained with respect to the trailer 210A simply for ease of explanation. However, the process 400 may similarly be implemented for each of the other trailers 210B-210N. Further, the process 400 is described with respect to order information received from a customer. In other embodiments, the order information may be received from other entities that have access to the order information. Additionally, the process 400 is explained with respect to order information.” However, in other embodiments, the process 400 may be implemented using other or additional types of relevant information (e.g., maintenance information, etc.). Thus, the process 400 may be implemented by the yard check engine 205 to validate or update the trailer status determined at the operation 320 of the process 300. As such, the process 400 may improve the accuracy of the trailer status determined by the yard check engine 205.

The process 400 begins at operation 405 in response to determining the status of the trailer 210A at the operation 320. In some embodiments, the process 400 then determines whether the trailer status of the operation 320 is currently accurate or whether the trailer status should be updated based upon additional information or inputs received at the yard check application 200. In some embodiments, the process 400 may be executed each time the current status at the operation 320 is determined. In other embodiments, the process 400 may be executed periodically and/or when new information is available. At operation 410, the yard check engine 205 receives order information from an order system of the customer. The order information may include what type of cargo is assigned to the trailer 210A, the amount of cargo that is assigned to the trailer 210A, the cargo delivery plan such as when the cargo is supposed to be loaded or unloaded, the stop locations on the delivery route, a start site for the cargo, a destination site for the cargo, the day/time the cargo is to be picked up, delivered, estimated day/time the trailer 210A is expected to depart and/or arrive, etc. In some embodiments, the yard check engine 205 receives order information continuously as new information becomes available or at predetermined time intervals. For example, the yard check engine 205 may receive order information from an order system once a day, a week, etc. The frequency with which the yard check engine 205 receives updated order information may be determined based on user input. Further, the order information may include information pertaining to the current order to which the trailer 210A is assigned and/or information pertaining to any past and/or future orders assigned to that trailer. In other embodiments, the yard check engine 205 may receive information in addition to or other than the order information, which may be used to validate or update the current status of trailers 210.

In some embodiments, the yard check engine 205 may be configured to integrate customer or third party yard management information into the yard check application 200 in order to aid and improve the determination of trailer status. For example, the yard check engine 205 may be configured to integrate third party system information and present a single application and interface that informs users of the statuses of trailers 210 with the added information from the third party system. The yard check engine 205 may also be configured to provide the third party management system with determined information on the tracked trailers 210, such as trailer status data.

At operation 415, the yard check engine 205 compares the order information received at operation 410 against the trailer status determined from sensor data, for example, at the operation 320. In some embodiments, the yard check engine 205 validates the trailer status or updates the trailer status determined at the operation 320. For example, if the yard check engine 205 determined at the operation 320 that the trailer 210A is empty, at the operation 410, the yard check engine may review order information (or other received information) to determine whether the trailer is expected to be empty. For example, if the current (e.g., the most recent) order information indicates that the trailer 210A is expected to be loaded at a given future time and an immediately previous order information indicates that the trailer was unloaded at a past time, the yard check time may conclude that the trailer is currently empty. Similarly, if the yard check engine 205 determines (e.g., from a maintenance report input into the yard check application 200) that the trailer 210A is in maintenance currently and the type of maintenance that the trailer is in requires the trailer to be empty, the yard check engine 205 may confirm that the trailer is likely empty right now. Thus, the yard check engine 205 may cross-reference the status of the trailer 210A determined at the operation 320 with other types of external information (e.g., the order information, maintenance information, etc.) received at the operation 410 to either validate (e.g., confirm) the trailer status or conclude that the current trailer status is likely wrong and needs to be updated. The yard check engine 205 may similarly determine whether the trailer 210A is currently loaded or not.

Additionally, if the yard check engine 205 confirms that the trailer 210A is loaded, the yard check engine 205 may also attempt to validate the type of cargo within the trailer. For example, the yard check engine 205 may determine (e.g., from the order information) whether the trailer 210A is currently assigned to an order, and if so, the type of cargo that the trailer 210A is intended to carry. The yard check engine 205 may then cross-reference the type of cargo information from the order information with the type of cargo identified at the operation 320 to validate whether the order information from the order system confirms the trailer status or whether there is a discrepancy.

The yard check engine 205 may also determine whether the trailer 210A is inbound or outbound based on the order information (and/or other information). For example, if the yard check engine 205 determines from the order information that the trailer 210A dropped off freight at Site A at Time A and is designated to pick up freight from Site B at Time B, the yard check engine 205 may determine that the trailer is likely inbound to site B. If the current status of the trailer 210A determined at the operation 320 showed the trailer to be inbound, the yard check engine 205 may confirm that status. On the other hand, if the current status of the trailer 210A determined at the operation 320 indicated that the trailer was outbound, the yard check engine 205 may update the status of the trailer and/or use/request other information to determine the correct status. Similarly, based on the order information or other types of information input into the yard check application 200, the yard check engine 205 may determine whether the trailer 210A is expected to be located on the yard or outside the yard (e.g., en-route to a site).

At operation 420, the yard check engine 205 updates the trailer status based upon the determination at the operation 415. For example, if the yard check engine 205 determines at the operation 415 that the current status of the trailer 210A as determined at the operation 415 matches the current status of that trailer determined at the operation 320, the yard check engine may confirm or validate that the current status of the trailer is accurate. In such cases, the operation 420 may be skipped. On the other hand, if the yard check engine 205 determines at the operation 415 that the current status of the trailer 210A as determined at the operation 415 does not match the current status of that trailer determined at the operation 320, the yard check engine may update the status of the trailer with the status determined at the operation 415. In some embodiments, the yard check engine 205 may use other types of information and/or request a manual inspection of the trailer to confirm the current status of the trailer before updating the current status at the operation 420.

In some embodiments, when updating the status, the yard check engine 205 may indicate that the trailer status determined based on sensor data at the operation 320 is being updated. In some embodiments, the yard check engine 205 may also include the reason for the update and may include (e.g., append) the information (e.g., the order information) based on that which the current status is updated. In some embodiments, the yard check engine 205 may also indicate the previous trailer status. In some embodiments, the yard check engine 205 may generate a flag or alarm notification if there is a discrepancy between the trailer status determined at the operation 320 and the operation 415. For example, the yard check engine 205 may generate an alarm notification that indicates the sensor data was inaccurate. Therefore, if a sensor 240N in the trailer 210N is faulty and provided inaccurate sensor data, the yard check application 200 may flag the sensor 240N for a manual checkup or maintenance to reduce the likelihood of incorrect trailer statuses determined based on sensor data in the future. In some embodiments, at the operation 420, the yard check engine 205 generates a push notification when a trailer status is changed based on a discrepancy determined at the operation 415. As such, a manager of the trailer and shipments may be notified, via the yard check application 200, if the current status of the trailer is updated. The process 400 ends at operation 425.

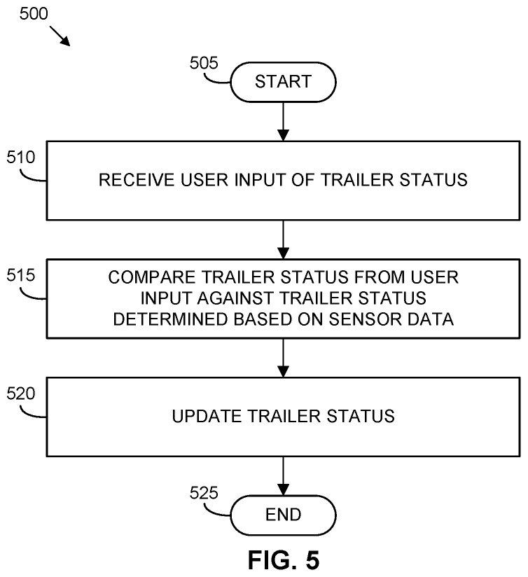

Referring now to FIG. 5, a flowchart outlining operations of a process 500 is shown, in accordance with some embodiments of the present disclosure. The process 500 may be implemented by the yard check engine 205 of the yard check application 200. The process 500 may be used to update the current status determined at the operation 320 of FIG. 3. Therefore, the process 500 may begin at operation 505 with the determined current status computed at the operation 320 of FIG. 3. Thus, in some embodiments, the process 500 may be executed before the process 400. In other embodiments, the process 500 may begin after the operation 420. Thus, although the process 500 is described below as being executed upon determining the current status at the operation 320, in some embodiments, the process 500 may be executed with the current status as validated by the process 400. Yet again, the process 500 is explained with respect to the trailer 210A to simplify the explanation of the process. However, the process 500 may similarly be implemented for each of the other trailers 210B-210N.

At operation 510, the yard check engine 205 receives user input for the trailer 210A. In some embodiments, a user may walk around a yard with a mobile device or other type of handheld device that is configured to communicate with the yard check application 200. The user may use the mobile device or the handheld device to send information to the yard check engine 205 upon manually inspecting the trailer 210A. For example, the user may manually check the trailer 210A and determine whether the trailer is empty or loaded. The user may also determine the type of cargo that may be loaded in the trailer 210A. Upon inspecting the trailer 210A, the user may send one or more inputs to the yard check engine 205 via the handheld device or mobile device. The user may also determine whether the trailer 210A is actually located on the yard, and if so, the exact location of that trailer on the yard.

In some embodiments, the yard check engine 205 may be configured to present a user interface on the user's mobile device or handheld device that provides a list of the trailers 210 that the user should see based on a current location of the user's mobile or hand held device (e.g., GPS location data from the mobile device or handheld device of the user) and/or the current locations of the trailers as determined at the operation 320. In other embodiments, the yard check engine 205 may present a list of all trailers that are expected to be on the yard. For each trailer on the list, the yard check engine 205 may also present the current statuses of the trailer as determined at the operations 320 and/or 415. For example, for the trailer 210A, the information presented on the user interface of the user's mobile device or hand held device may include whether the trailer is empty or loaded, if loaded, the cargo type, the exact location of the trailer on the yard, information to identify the trailer on the yard, and any other desired information. The user may then walk/drive around the yard with the mobile device or handheld device, and confirm the current status of each trailer 210 on the yard. In some embodiments, the user may be designated to walk/drive around the yard at predetermined days and/or times, and/or as desired.

Thus, for each trailer on the list, the user may walk/drive around the yard to locate that trailer. In some embodiments, if a user is unable to locate a trailer (e.g., the trailer 210A) that is listed as being on the yard by the yard check engine 205, the user interface presented on the user's mobile device or hand held device may allow the user to send a notification to the yard check engine that the trailer is not on the yard. In some embodiments, the user interface may allow the user to change the status of the trailer indicating that the trailer is not on the yard. In some embodiments, if the user locates the trailer 210A on the yard but not at the location indicated on the user interface, the user may send a notification to the yard check engine 205 indicating the actual location where the trailer is located and/or manually change the status of the trailer via the user interface of the mobile device or handheld device.

Similarly, upon locating the trailer 210A in the yard, the user may scan a barcode or use other identification that is associated with the trailer to confirm the identity of the trailer. The user may then also open the trailer/peek into the trailer 210A, or use other mechanisms, to determine whether the trailer is empty, loaded, and/or the type of cargo loaded within the trailer. In some embodiments, the user may also determine whether the trailer 210A is completely full or if there is more room for additional cargo. Upon manually inspecting the trailer 210A, the user may either send a notification or user input to the yard check engine 205 via the mobile device or hand held device indicating the observed status or directly update the current status of the trailer on the mobile device or hand held device.

Further, the notification or user input received by the yard check engine 205 from the mobile device or hand held device may include several types of inputs such as audio input, textual input, a touchscreen input, visual input, and/or any other kind of input that is enabled by the input device 115. In some embodiments, the user input is received via radio frequency identification (RFID) tags or a scan of a barcode. For example, the yard check engine 205 may receive user input of a photo of the cargo space inside the trailer 210A, external surroundings of the trailer, and/or the trailer itself. In another example, the yard check engine 205 may receive user input of a voice command stating that the trailer status is empty. As yet another example, the yard check engine 205 may receive user input as a selection from a drop down menu that provides the various options for trailer status via the user interface on the user's mobile device or hand held device.

At operation 515, the yard check engine 205 compares the current trailer status determined at the operations 320/415 against the user input received at the operation 510. In some embodiments in which the user directly updates the status of the trailer 210A via the mobile device or hand held device, the operation 515 may be skipped or the yard check engine may still perform the operation 515 in the background before allowing the status to change. The yard check engine 205 may determine whether the user input received at the operation 510 validates the current status, or whether there is a disagreement between the two statuses.

In response to determining, by the yard check engine 205, a disagreement between the current status determined at the operations 320/415 and the user input received at the operation 510, the process 500 proceeds to operation 520. In some embodiments, if the yard check engine 205 determines agreement between the trailer statuses, the process 500 may end. In some embodiments, however, the yard check engine 205 may update the trailer status with an indication that the trailer status has been validated by user input at the operation 520 and include information such as that discussed above in FIG. 4.

At the operation 520, the yard check engine 205 updates the trailer status of the trailer 210A that received user input. The yard check engine 205 may update the trailer status to set the status to a new status determined from the received user input. In some embodiments, the yard check engine 205 may rewrite in memory (e.g., memory device 110) an outdated or incorrect trailer status with a new trailer status. The yard check engine 205 may generate an alarm notification or flag if there is disagreement between the trailer status determined at the operations 320/415 and the trailer status from the received user input. For example, the yard check engine 205 may generate an alarm notification that indicates the sensor data was inaccurate and/or outdated. The yard check engine 205 may generate a push notification when a status of the trailer 210A is updated based on a determined difference at the operation 515. In response to determining an agreement between the received user input and the trailer status determined based on sensor data, the yard check engine 205 may update the trailer status to designate that the trailer status determined based on sensor data in process 300 has been confirmed.

In some embodiments, the user input received may additionally or alternatively include a request for the yard check engine 205 to perform an action. Such user input may be received via the mobile device or hand held device of the user walking/driving around the yard or from another user in any designated way. For example, the user input may include a request for the yard check engine 205 to assign an empty trailer to a specific/new order. As another example, the user input may include a request for the yard check engine 205 to generate and submit a maintenance order for the trailer 210A. In some embodiments, the user input may include a type of maintenance that is needed for the trailer 210A, such as a type of part on the trailer 210A that may need a repair, etc. In other embodiments, the user input may be for performing additional or other actions. The process 500 ends at operation 525.

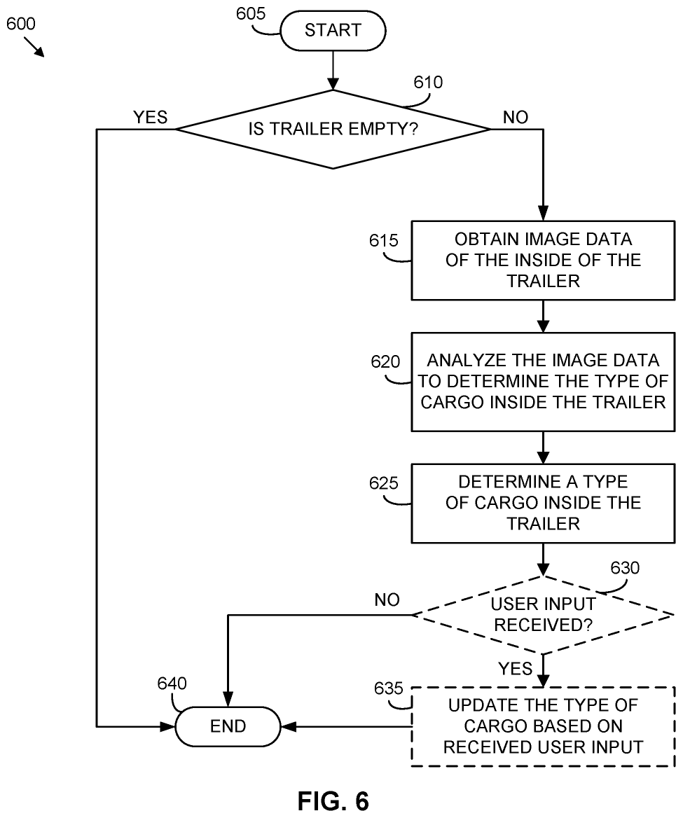

Referring now to FIG. 6, a flowchart outlining operations of a process 600 is shown, in accordance with some embodiments of the present disclosure. The process 600 may be implemented by the yard check engine 205 of the yard check application 200. The process 600 may be used to determine a type of cargo inside the trailers 210. For purposes of explanation, the process 600 is explained with respect to the trailer 210A. However, the process 600 is equally applicable to the other trailers 210B-210N also. In some embodiments, the process 600 may be used to determine a type of cargo inside the trailer 210A at the operations 320, 415, and/or 515. The process 600 begins at operation 605 and determines whether the trailer 210A is full or empty at operation 610.

If the yard check engine 205 determines that the current trailer status indicates that the trailer 210A is empty, then the determination of the type of cargo within the trailer is irrelevant and the process 600 ends at operation 640. However, if the yard check engine 205 determines that the current trailer status indicates that the trailer 210A is loaded, the yard check engine 205 proceeds to operation 615. It is to be understood that when the trailer 210A is “loaded,” the trailer need not be completely full. Rather, if there is any cargo inside the trailer 210A or the trailer is more than a predetermined amount full, the status of the trailer may be considered “loaded.” Thus, the status “loaded” may include partially full.

At the operation 615, the yard check engine 205 obtains image data of the inside of the trailer 210A. In some embodiments, the yard check engine 205 transmits a signal to activate a camera or video camera system to capture an image of the cargo space inside the trailer 210A. In some embodiments, the yard check engine 205 also transmits a signal to a lighting system to operate so that the inside of the trailer can be viewed in an image captured by a camera or other sensors 240 within the trailer 210A. In other embodiments, the camera or video camera system may include functionalities to capture images in dark areas. Therefore, in other embodiments, a lighting system may not be utilized. In other embodiments, the sensor 240A may capture the image/activate the lighting system, as discussed with respect to the operations 310 and 315 and without specific instructions from the yard check engine 205. In some embodiments, the yard check engine 205 may obtain image data from multiple image sensors 240 mounted on the inside of the trailer 210A. For example, cameras may capture images from various angles and/or locations of the inside of the trailer 210A, such that any area inside the trailer 210A that may hold cargo is captured in an image. In some embodiments, the image data received by the yard check engine 205 at the operation 615 may include a timestamp of each image captured by a camera or other sensor 240 inside the trailer 210A. In some embodiments, the image data received by the yard check engine 205 may also include a trailer identifier for the trailer 210A associated with the captured image(s) or any other information as discussed above with respect to the operations 310 and 315.

At operations 620 and 625, the yard check engine 205 compares the image data with a baseline image of cargo in the trailer 210A and determines the cargo type. In some embodiments, the yard check engine 205 may employ image processing techniques to compare the image data with the baseline image. In some embodiments, baseline images of various cargo types may be stored within the yard check application 200. For example, the yard check engine 205 may have stored images in memory (e.g., memory device 110) of each type of cargo that is provided by the customer, each type of cargo that has been stored in the trailer 210A in the past, and/or each type of cargo that is assigned to be delivered by the trailer 210A. Upon receiving the image data at the operation 615, the yard check engine 205 may compare that image data with one or more of the stored baseline images to identify an exact or close match. Upon finding an exact or close match, the yard check engine 205 may determine that the cargo type inside the trailer 210A is the same cargo type that is associated with the baseline image(s) having the exact or close match. In some embodiments, if the image data matches with multiple baseline images having varying cargo types, the yard check engine 205 may employ other mechanisms to confirm the cargo type (e.g., order information, user input, artificial intelligence, etc.).

In some embodiments, the yard check engine 205 may additionally or alternatively use artificial intelligence and/or machine learning to analyze the image data of the operation 615. For example, the yard check engine 205 may utilize supervised and/or unsupervised machine learning techniques, such as support vector machines, Naïve Bayes classification models, k-nearest neighbor classification models, linear regression models, logistic regression models, Gaussian Process Regression models, decision trees, neural networks, deep neural networks, k-means clustering, Hidden Markov models, and the like to process the image data. In some embodiments, the artificial intelligence models are trained using numerous images of each type of cargo provided by the customer. The artificial intelligence models may also be trained using numerous images of the trailer 210A and the yard site.

At the operation 625, the yard check engine 205 determines a type of cargo inside the trailer 210A based on the results from the operation 620. For example, if a match (exact or close) is determined between the image data from the inside of trailer 210A and one or more baseline images of a type of cargo, the yard check engine 205 sets a parameter of the cargo type inside the trailer 210A to the cargo type in the matched, baseline image(s). Beneficially, by determining the type of cargo stored in the trailer 210A, the yard check application 200 can be utilized to determine if the trailer 210A has been loaded with an incorrect type of cargo, the type of cargo that is being transported on a delivery route, and/or the type of cargo that is being stored on the trailer 210A that needs to be unloaded. In some embodiments, the yard check engine 205 generates an alert to notify a user if a match cannot be determined above a predetermined threshold. As such, a user may receive the alert, indicating that unknown cargo is stored in the trailer 210A.

At operation 630, the yard check engine 205 may determine whether user input is received for the trailer 210A. The operation 630 may optionally (as indicated by the dashed lines in FIG. 6) be executed by the yard check engine 205. For example, the process 600 may proceed from the operation 625 directly to ending at operation 640 instead of proceeding to the operation 630, such as if the yard check application 200 does not permit receiving user input to modify the type of cargo stored in trailer 210A. In some embodiments, the user input of the operation 630 may be the user input that is received at the operation 510 discussed above. In some embodiments, the yard check engine 205 may request a manual inspection of the trailer 210A to confirm the cargo type. Thus, the user input may be from a user walking/driving around the yard and manually inspecting the trailer 210A. After checking inside the trailer 210A, the user may enter input of the cargo type stored in the trailer 210A. In some embodiments, the user input may be received as a tactile input, an audio input, a keyboard input, and the like. In response to determining no user input has been received, the process 600 ends at operation 640. However, if the yard check engine 205 receives user input regarding the cargo stored in the trailer 210A, the yard check engine 205 updates the type of cargo based on the received user input at operation 635. The yard check engine 205 may also optionally execute the operation 635, as indicated by the dashed lines in FIG. 6 of the operation 635. In some embodiments, the process 600 proceeds from the operation 625 to the operation 640, without proceeding to both of the operations 630 and 635. In some embodiments, the user input received at the operation 630 may be the same as the cargo type determined by the yard check engine 205. In this instance, the user input received by the yard check engine 205 may be used to validate the determined type of cargo inside the trailer 210A.

Therefore, the yard check application 200 provides the ability to determine in real-time, or substantially real-time, the type of cargo stored in numerous tracked trailers (e.g., the trailers 210). This provides customers the advantage of being able to monitor which ones of the trailers 210 are storing what kind of cargo and track numerous cargo being shipped between sites. As such, the yard check application 200 may help customers locate cargo that needs to be unloaded and/or cargo that needs to be shipped. Furthermore, the yard check application 200 may mitigate the likelihood of missing cargo and/or improper assignments of cargo to trailers 210 for delivery.

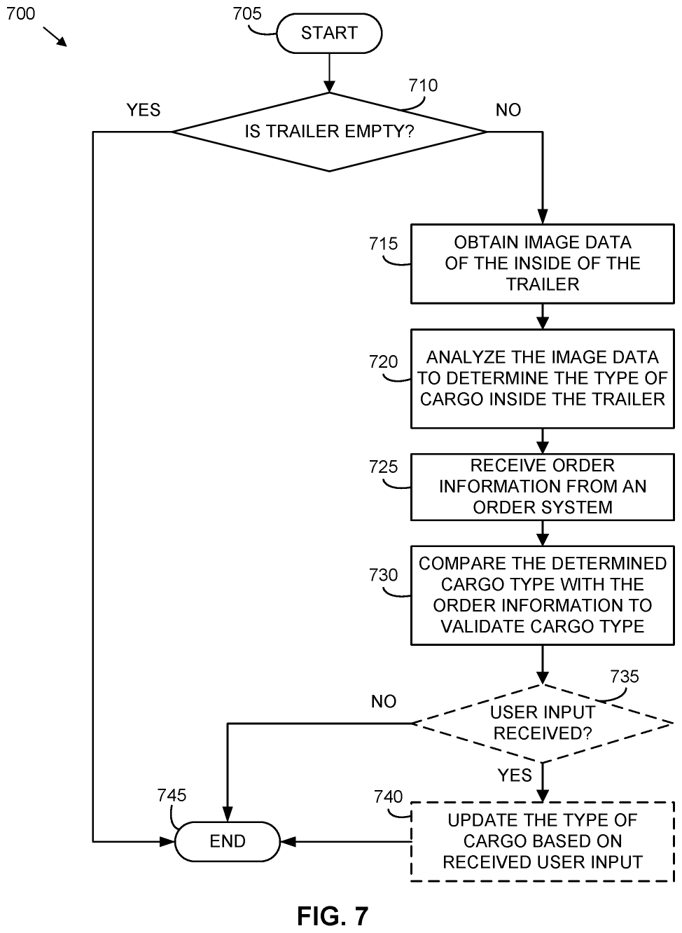

Referring now to FIG. 7, a flowchart outlining operations of a process 700 is shown, in accordance with some embodiments of the present disclosure. The process 700 may be executed by the yard check engine 205 of the yard check application 200. The process 700 is somewhat similar to the process 600 and may be used to determine/confirm the cargo type at the operations 320, 415, 515. The process 700 begins at operation 705 and at operation 710, the yard check engine 205 determines whether the trailer 210A is empty similar to the operation 610. In response to determining, by the yard check engine 205, that the trailer status indicates the trailer 210A is empty, the process 700 concludes at operation 745. On the other hand, in response to determining, by the yard check engine 205, that the trailer status indicates that trailer 210A is not empty, the yard check engine 205 proceeds to operation 715.

At the operation 715, the yard check engine 205 receives image data of the inside of the trailer 210A. The operation 715 is similar to the operation 615, and therefore not described again. Upon receiving the image data, the image data is analyzed at operation 720 similar to the operations 620 and 625.

At operation 725, the yard check engine 205 receives order information from an order system of the customer, as discussed above in FIG. 4. In some embodiments, the yard check engine 205 may receive other or additional information. At operation 730, the yard check engine 205 compares the determined cargo type with the order information to validate the cargo type stored in trailer 210A. The yard check engine 205 may confirm the determined cargo type with the order information by determining whether a different type of cargo type was assigned to the trailer, for example. In some embodiments, the yard check engine 205 may validate the determined cargo type in the trailer 210A by confirming that an order has been placed by the customer for that specific type of cargo. For example, if the yard check engine 205 determines the cargo type inside a trailer 210A as an assembled motorcycle, the yard check engine 205 searches the order information to confirm that an order has been made for an assembled motorcycle to be delivered by the trailer 210A. In some embodiments, in response to confirmation of the cargo type by the yard check engine 205, the yard check engine 205 may set a status of the tracked cargo as validated for the trailer 210A. In other embodiments, if the yard check engine 205 is unable to validate the cargo type, the yard check engine 205 may generate an alert notification to transmit to an output device 120 regarding the cargo in trailer 210A.

At operation 735, the yard check engine 205 may determine whether user input is received for the trailer 210A. The operation 735 may be an optional operation of the process 700, as indicated by the dashed lines of the operation 735 in FIG. 7. In some embodiments, the process 700 proceeds directly from the operation 730 to the operation 745. For example, the yard check application 200 may not allow user input to change the type of cargo in the trailer 210A. The operation 735 is similar to the operation 630, and therefore, not described again. If the cargo type determined at the operation 730 and/or the operation 720 matches the cargo type indicated in the user input or if no user input is received, the process ends at the operation 745. Otherwise, the cargo type is updated based on the user input at operation 740. As such, the operation 740 also is optionally executed by the yard check engine 205, as indicated by the dashed lines in FIG. 7. If the operation 735 is not executed in the process 700, the operation 740 also is not executed by the yard check engine 205, for example.

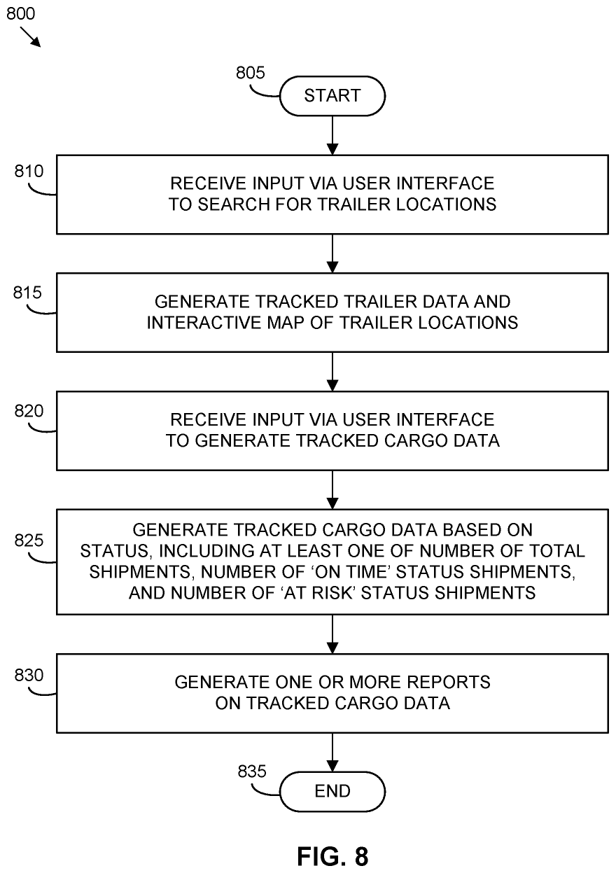

Referring now to FIG. 8, a flowchart outlining operations of a process 800 is shown, in accordance with some embodiments of the present disclosure. The process 800 may be executed by the yard check engine 205 of the yard check application 200. In some embodiments, the process 800 may be used to generate information regarding tracked trailers and cargo in the trailers 210 at various location sites. In some embodiments, the yard check engine 205 implements one or more of the processes of FIGS. 3-7 in order to generate the information provided in the process 800. The process 800 starts at operation 805 with providing a user interface, such as the user interface 900 (FIG. 9), of the yard check application 200.

At operation 810, the yard check engine 205 receives input via the user interface 230 to search for locations of the trailers 210 associated with an entity (e.g., a customer). In some embodiments, the user input may include search criteria for the yard check engine 205 to filter the search results. For example, the received user input may include a city/state of the trailer(s), trailer identifier(s), trailer status(es), trailer site(s), etc. In some embodiments, the user input may be received as a selection of predetermined options from a drop down menu, such as set trailer statuses that the user may select. Further, in some embodiments, the information or search results that are retrieved based on the user input may include tracked information such as a location of the trailer, a current status of the trailer, number of days the trailer has been in the current status, a trailer identifier number and/or keyword, a trailer type, and so on.

At operation 815, the yard check engine 205 generates the tracked information and displays at least some of the tracked information on an interactive map showing the trailer locations of the trailers 210. The tracked information and the interactive map of the trailer locations that were returned from the search by the yard check engine 205 may be displayed on the user interface 230 of the yard check application 200. In some embodiments, the tracked information may be organized in various forms, such as a table, a graph, a widget, etc. In some embodiments, a user may interact with the interactive map to zoom in or out of the view in order to view more precise locations of the trailers 210 and/or data specific to each trailer in response to hovering over the image of one of the trailers 210 on the generated interactive map. In some embodiments, the tracked information (also referred to herein as tracked trailer data) includes at least one of a search result number, a trailer identifier number and/or keyword, a current city location, a current state location, a current site location, a trailer type, a trailer status, and a number of days in status, and so on as discussed above. In some embodiments, the tracked information may represent data in color coded form. For example, the color coding may be based upon the type of trailer (e.g., intermodal versus non-intermodal, etc.), location of the trailer (e.g., how far away from a central site the trailer is located), whether the trailer is on the yard or en-route, etc. In other embodiments, the tracked information may use other indicia or representations for data differentiation.

At operation 820, the yard check engine 205 receives another input via the user interface 230 to generate tracked cargo data for the trailers 210. In some embodiments, a user may input via the user interface 230 to view tracked statuses of cargo currently in transportation, at customer sites, and/or at stop locations on a delivery route. The tracked cargo data may include a starting location of the cargo, a delivery location of the cargo, a planned delivery itinerary including a shipment time, estimated time of arrivals at each stop on the delivery route, and a delivery time, a current status of the cargo, a risk factor of the cargo, an at risk reason, a mode of the cargo, a SCAC (e.g., Standard Carrier Alpha Code) of the cargo, a BOL (e.g., Bill of Lading) of the cargo, and/or a weight of the cargo. In some embodiments, the user input may include search criteria for the yard check engine 205 to filter the search results. For example, the received user input may include a shipping departure location and a shipping destination location. In some embodiments, the user input may be received as a selection of predetermined options from a drop down menu, such as set trailer statuses that the user may select.

At operation 825, the yard check engine 205 generates tracked cargo data. The yard check engine 205 may generate the tracked cargo data based on status, including at least one of number of total shipments, number of “On Time” status shipments, and number of “At Risk” status shipments. “On Time” status shipments may refer to shipments that have a delivery status as on time for the scheduled delivery time. “At Risk” status shipments may refer to shipments that have a delivery status as at risk for having a predicted delivery time after the scheduled delivery time. In some embodiments, the yard check engine 205 may export a summary of the tracked cargo data, including the risk factor of each of the tracked loads and the at risk reason of any tracked loads at risk. In some embodiments, the yard check engine 205 saves the generated tracked cargo data in memory (e.g., memory device 110) with a timestamp of when the tracked cargo data was generated. The yard check engine 205 may also generate a tracking details option at the operation 825. In response to selection of the tracking details option, the yard check engine 205 may generate a window displaying the delivery route for a selected, tracked shipment. The displayed delivery route may indicate the path from the shipping departure location, each stop location, and the shipment delivery location, along with the planned estimated time of arrival of the cargo at each location on the delivery route.

At operation 830, the yard check engine 205 generates one or more reports on the tracked cargo data. The yard check engine 205 may generate reports including tracked cargo data on all active loads, loads in transit, loads at risk, pick up today loads, deliver today loads, deliver tomorrow loads, and/or delivered in the last seven day loads. In some embodiments, in response to receiving user input to save one of the generated reports, the yard check engine 205 may store the generated report in memory (e.g., memory device 110) for quick access to the report. As such, a report that may be frequently viewed, such as a report including tracked cargo data on all active loads, may be easily and quickly accessed by a user via a user interface of the yard check application 200. The process 800 ends at operation 835.

Referring now to FIG. 9, the user interface 900 of the yard check application 200 is shown, in accordance with some embodiments of the present disclosure. In some embodiments, the user interface 900 is generated and displayed by the yard check engine 205. In some embodiments, the user interface 900 is a home page or dashboard of the yard check application 200. The user interface 900 may allow a user to view current locations of the trailers 210 associated with the user. In some embodiments, the user interface 900 provides users the capability of entering search criteria to view and/or filter search results for trailer information. In some embodiments, the user interface 900 includes menu options 905 and a searching window 920, having trailer identifier(s) input field 910, city/state input field 915, trailer status input field 925, and site location input field 930. The trailer identifier(s) input field 910 may provide a user with the option to search for one or more trailers 210 using the associated trailer identifiers. The city/state input field 915 may provide a user with the option to search for one or more trailers 210 based on a current city/state location of the trailer(s). The trailer status input field 925 may provide a user the option to search for one or more trailers 210 based on the current status of the trailer(s). The site location input field 930 may provide a user the option to search for one or more trailers 210 based on a site location of the trailers. The various input fields of the searching window 920 are described in greater detail below. The user interface 900 may also include a results summary window 950, a trailer table 940, and an interactive map 945.

In some embodiments, the menu options 905 may include an option for a home option, a track option, a documents option, a yard check option, a preferences option, a customer option, a new customer option, a user option, an internal users option, a feedback option, and/or a help option. In other embodiments, the menu options 905 may include other or additional options. In some embodiments, the customer option, the new customer option, the user option, and the internal users option are displayed in response to a selection of the preferences option. It is to be understood that the shape, size, orientation, location, and other configuration of any of the features of the user interface 900 are only an example and may vary from one embodiment to another.

The feedback option of the menu options 905 may allow a logged-in user to provide feedback or ask a general question that may then be transmitted to a site support team of users. The user may be able to input feedback via a user interface of the yard check application 200 to report a problem, submit an idea, ask a question, etc. The help option of the menu options 905 may allow a logged-in user to quickly access contact information for customer service contacts, sales contacts, and site support contacts. Furthermore, the help option may provide a list of selectable links to view online answers to frequently asked questions.

The preferences option may allow a user of the yard check application 200 to view additional options to configure settings of the yard check application 200. For example, selection of the preferences option may display additional options for configuring customers of the yard check application (e.g., a customer option and a new customer option). In some embodiments, users of the yard check application 200 with security access of a “Customer Administrator” may access the customer option from the menu options 905. In some embodiments, a “Customer Administrator” user may maintain users on an account. For example, the “Customer Administrator” user may add a user to a specific customer account, remove a user from the customer account, and edit details of each user account, such as first and last name, email, and/or role of the user. The role of the user may include either a “Customer Administrator” role or a “Customer Track” role, for example. In some embodiments, the user option may allow an administrative user to configure additional settings of other user accounts and/or view user information. The preferences option may also include an internal users option, which may display information regarding users associated with the provider of the yard check application 200. In some embodiments, selection of the customer option and/or the user option generates a user interface that includes options for subscription settings. For example, a user of the yard check application 200 may select an option to receive daily tracking reports and indicate the time of day to receive the daily tracking report.

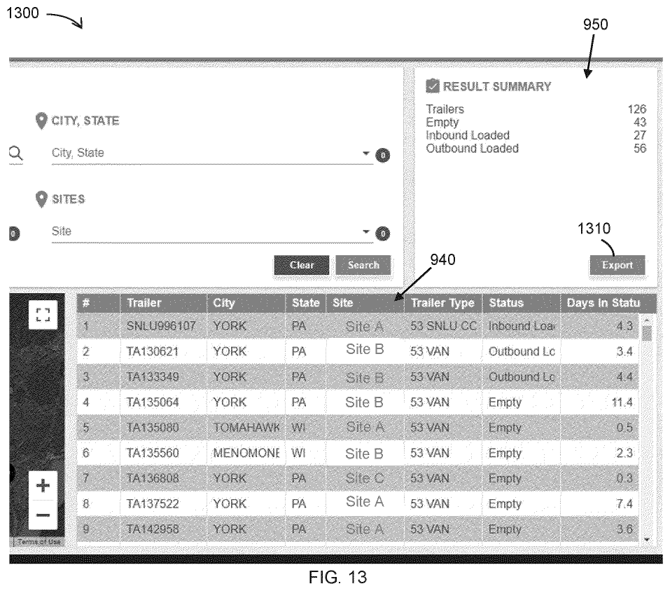

The user interface 900 is also shown to include the trailer table 940. The trailer table 940 may populate with each of the detected trailers 210 at various locations in response to selection of the search option in the searching window 920. In some embodiments, each row of the trailer table 940 corresponds with a trailer icon indicated in the interactive map 945. In some embodiments, upon selection of the trailer icon in the interactive map 945, the corresponding entry in the trailer table 940 may be displayed and/or highlighted, and vice versa. In some embodiments, the user interface 900 includes a results summary window 950. The trailer table 940 and the results summary window 950 are described in greater detail below with respect to zoomed-in view 1300 (FIG. 13).

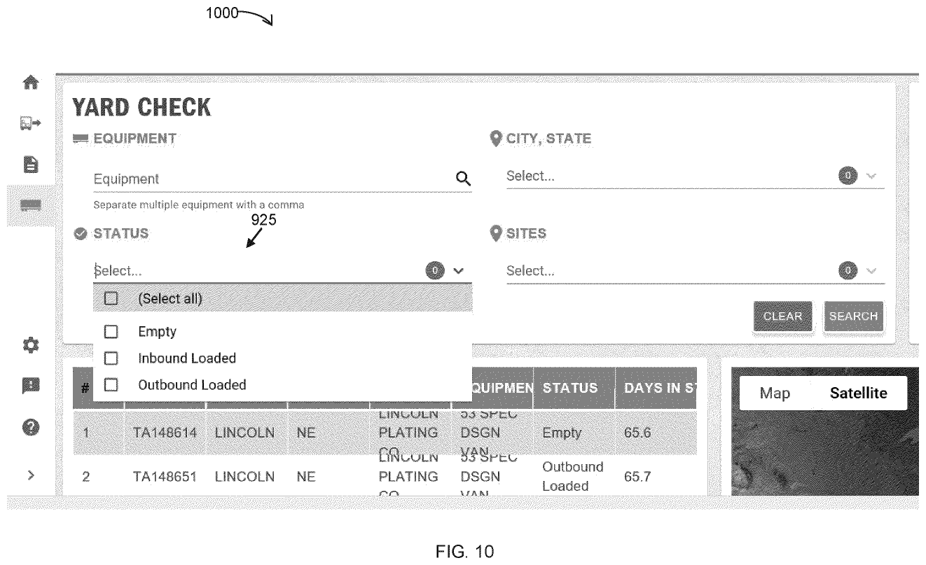

Referring now to FIG. 10, an example of a user interface 1000 of the yard check application 200 is shown, in accordance with some embodiments of the present disclosure. In some embodiments, the user interface 1000 is generated and displayed by the yard check engine 205. The user interface 1000 shows the searching window 920 in greater detail. The user interface 1000 shows the trailer status input field 925 feature of the user interface 900 in greater detail. The user interface 1000 shows a selection of the trailer status input field 925. In some embodiments, the user interface 1000 may present a drop-down list of possible statuses for the trailers 210. A user may then select whether to search for the trailers 210 that have an “Empty” current status, an “Inbound Loaded” current status, an “Outbound Loaded” current status, and/or a “Select all” option. It is to be understood that the number of statuses shown, the type of statuses shown, and the manner/order in which those statuses are shown may vary in other embodiments. The current status of a trailer as “Empty” refers to a trailer that is not currently holding and/or transporting any cargo. “Inbound Loaded” may refer to any trailer that is carrying cargo that is being delivered to the customer. For example, a trailer carrying a shipment of parts needed to create a product made by the customer may be considered “Inbound Loaded.” In some embodiments, “Outbound Loaded” may refer to any trailer that is hauling cargo that is to be delivered to a different site of the customer or a place of business. In one example, a trailer that is carrying freight that is an assembled product to be sold at a merchant location of the customer may have a current status of “Outbound Loaded.” In other embodiments, the various statuses may be presented in a form other than a drop down list. By selecting one or more statuses, the user may be able to search for the trailers 210 having a current status (e.g., as determined from FIGS. 3-8) that matches the selected status from the trailer status input field 925. For example, a manager planning allocation of trailers 210 and a route for drivers to deliver cargo loaded in the trailers 210 may want to determine how many trailers are currently empty. Therefore, the manager may choose to only search for empty trailers 210 by selecting the “Empty” current status option from the drop-down menu via the user interface 1000. As such, the yard check engine 205 may be configured to search for the trailers 210 tracked by the yard check application 200 by trailer status.

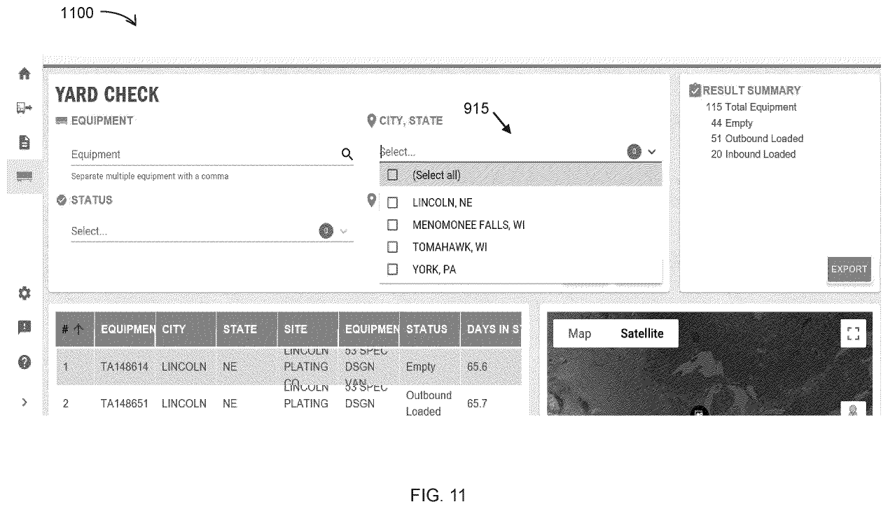

An example of a user interface 1100 of the yard check application 200 is shown in FIG. 11, in accordance with some embodiments of the present disclosure. The user interface 1100 shows the city/state input field 915 feature of the user interface 900 in greater detail, for example. The user interface 1100 may be generated by the yard check engine 205 and allows a user to search for trailers based on a current city/state of the trailer location. Thus, the user interface 1100 shows the searching window 920 in greater detail. In some embodiments, the user interface 1100 is generated by the yard check engine 205 in response to receiving a selection, via the user interface 900, of the city/state input field 915. The user interface 1100 may present a drop-down list of options for city/states having yard locations for the trailers 210. In some embodiments, the city/state option may include those cities and/or states where the trailers 210 travel to. In some embodiments, a user selects specific city/states to filter search results of the tracked trailers 210. Therefore, the yard check application 200 may provide the user the ability to view tracked trailer data, including the current locations, of trailers 210 that are only in the selected city/states.

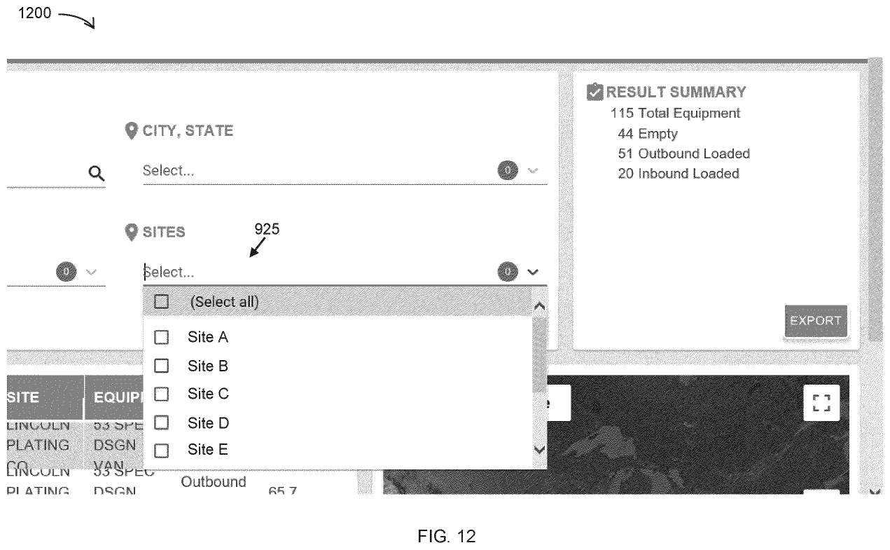

Referring now to FIG. 12, an example view of a user interface 1200 of the yard check application 200 is shown, in accordance with some embodiments of the present disclosure. The user interface 1200 shows the site location input field 930 feature of the user interface 900 in greater detail, for example. In some embodiments, the user interface 1200 is generated and displayed by the yard check engine 205 to provide users the ability to search for trailers 210 based on a current site location of the trailers 210. For example, a customer may have several sites in the same city/state. As such, the customer may want to view trailer locations and other tracked trailer data with regards to a specific customer site. The user interface 1200 may be generated by the yard check engine 205 in response to receiving, via the user interface 900, a selection of the site location input field 930. In some embodiments, the user interface 1200 presents a drop-down list of options for each site location associated with the logged-in user in response to a selection of the site location input field 930. The user may then choose certain customer site locations to filter the search results of the tracked trailers 210 generated by the yard check engine 205. As such, the yard check application 200 can allow a user to view and generate reports on tracked trailer data for specific customer site locations. For a customer with hundreds to thousands of trailers 210 monitored by the yard check application 200, this feature allows a user to be presented with the tracked trailer data without an excessive amount of results to sort through.

Turning now to FIG. 13, the zoomed-in view 1300 of the user interface 900 is shown, in accordance with some embodiments of the present disclosure. The zoomed-in view 1300 shows the results summary window 950 of the user interface 900 and the trailer table 940 of the user interface 900. The results summary window 950 includes a selectable export option 1310. In some embodiments, the results summary window 950 is generated by the yard check engine 205 to display the total number of the trailers 210, the number of empty trailers, the number of inbound loaded trailers, and the number of outbound loaded trailers that meet the search criteria entered in the searching window 920. The results summary window 950 may include other or different options, in other embodiments. In response to selection of the export option 1310, the yard check engine 205 may export a data file to improve the ease and accessibility of data consumption for the user of yard check application 200. In some embodiments, the trailer table 940 displays tracked trailer data of the search result number, the trailer identifier number and/or keyword, the city and state, the site location, the trailer type, the trailer status, and the number of days in status for the trailer for each of the trailers 210 that met the search criteria entered in the searching window 920. In some embodiments, the yard check application 200 may sort the trailer table 940 in response to a selection of the trailer data heading. For example, in response to a selection of the heading for the trailer table 940 of the days in status, the yard check engine 205 may re-sort the list to display the search results of trailers 210 in order from the least amount of days in status to the highest amount of days in status or vice versa.

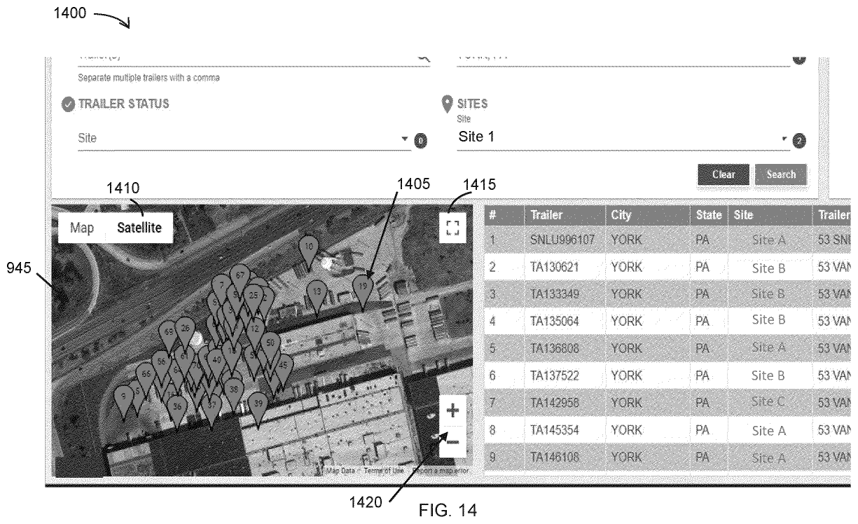

Referring now to FIG. 14, an example view 1400 of the user interface 900 is shown, in accordance with some embodiments of the present disclosure. The example view 1400 includes the interactive map 945 of user interface 900, trailer location icons 1405, selectable full screen option 1415, selectable display options 1410, and selectable zoom options 1420. The display options 1410 may allow a user of the yard check application 200 to toggle between a map view of the interactive map 945 and a satellite view of the interactive map 945. In some embodiments, in response to selection of the full screen option 1415, the yard check engine 205 generates a user interface that presents the interactive map 945 as a full screen view. In some embodiments, the yard check engine 205 generates and displays a trailer location icon 1405 for each tracked trailer returned in the results from the search and shown in the trailer table 940. As such, the yard check engine 205 may be configured to filter the interactive map 945 based on trailer status of the trailers 210. In some embodiments, the yard check engine 205 may be configured to generate the trailer location icons 1405 based on the trailer status of the corresponding trailers 210. The yard check engine 205 may be configured to color-code the trailer location icons 1405 or use different symbols to represent different trailer statuses. For example, trailers 210 with a trailer status of empty may have a red trailer location icon 1405, whereas trailers 210 that are outbound loaded or inbound loaded may have a green trailer location icon 1405.

In some embodiments, a user may zoom in and out on the interactive map 945 using zoom options 1420. Once the interactive map 945 is zoomed out a certain amount, the yard check engine may show one trailer location icon 1405 to represent several trailers 210 at a single site location. For example, if the interactive map 945 is zoomed out to view several customer site locations, the yard check engine will display one trailer location icon 1405 for each site location. In some embodiments, the one location icon for each site location displays the number of tracked trailers 210 at that site location in the icon and/or when a user hovers over the icon on the user interface 900. The interactive map 945 may have additional or other options.

In other embodiments, the yard check engine 205 is configured to generate an icon of a current location associated with the user, such as based on the GPS signal of a mobile device of the user. The yard check engine 205 may also be configured to display a list of the trailers 210 that the user should be able to view based on the user's current location. Furthermore, the user interface 900 may include a feedback option for a user to manually enter input that a trailer 210 could not be located that was listed as proximate the user by the yard check engine 205 on the user interface 900.

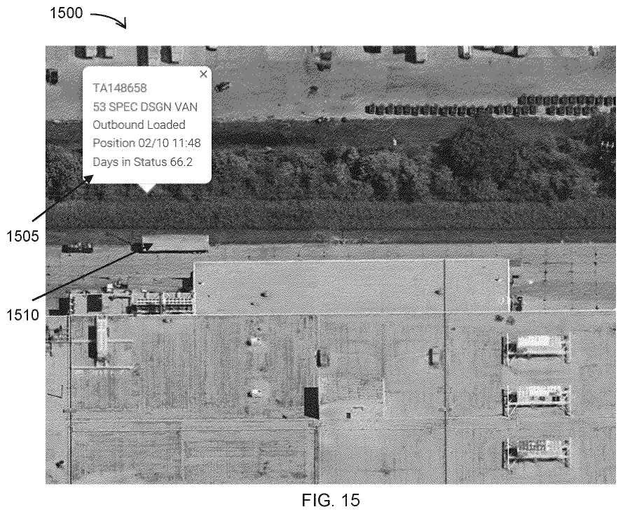

FIG. 15 shows an example view 1500 of the interactive map 945 and particularly of the yard, in accordance with some embodiments of the present disclosure. The example view 1500 includes a trailer details window 1505 and a trailer 1510. In some embodiments, when a cursor hovers over the trailer 1510 and/or a selection of the trailer 1510 is received, the yard check engine 205 generates and displays the trailer details window 1505 in the interactive map 945 on the user interface 900. In some embodiments, the trailer details window 1505 includes the trailer identifier number and/or keyword, the trailer type, the trailer status, date and time of position, and/or the number of days the trailer has been in status (i.e., tracked by the yard check application 200).

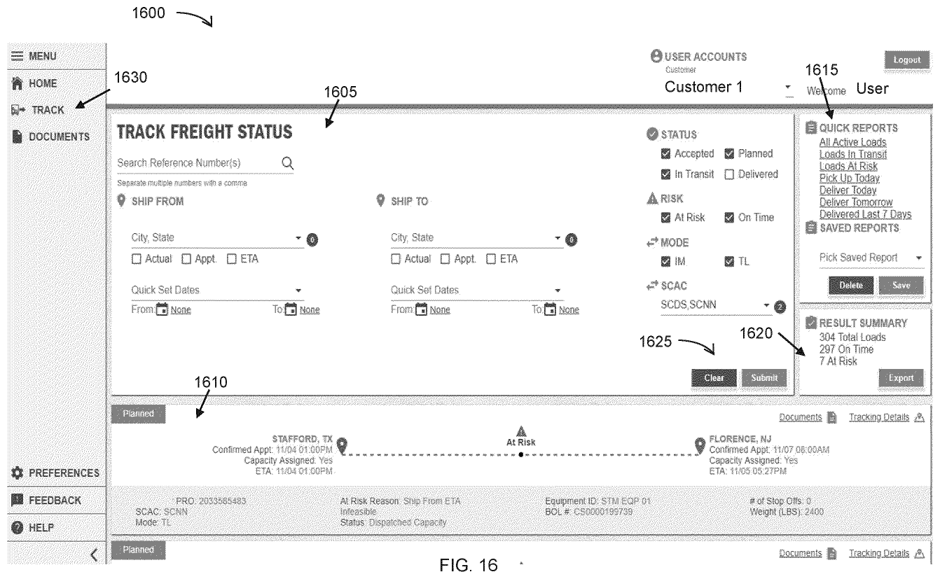

Referring now to FIG. 16, a user interface 1600 of the yard check application 200 is shown, in accordance with some embodiments of the present disclosure. In some embodiments, the user interface 1600 is generated and displayed by the yard check engine 205 in response to selection of the track option 1630 from the list of options shown in the user interface 900. The user interface 1600 includes a track freight status window 1605, track options 1625, reports window 1615, results summary window 1620, and planned order information window 1610, according to some examples. The track freight status window 1605 may include options to search reference numbers of shipping orders, enter shipment departure location, shipment delivery location, shipment departure date, shipment delivery date, shipment status, shipment risk factor, shipment mode, and/or shipment SCAC. In response to selection of the submit option in the track options 1625, the yard check engine 205 may populate the planned order information window 1610 with tracked information for each of the orders included in the search results. The reports window 1615 may include links to view reports on all active loads, loads in transit, loads at risk, loads for pick up today, loads for deliver today, loads for deliver tomorrow, and/or loads delivered the last seven days. In some embodiments, the reports window 1615 also includes options to save reports generated by the yard check application 200 and/or view previously saved reports. In some embodiments, the results summary window 1620 includes the total number of loads, the total number of loads with “On Time” status, and the total number of loads with “At Risk” status (e.g., loads that are at risk of being delivered late). The results summary window 1620 may also include an option to export the results. In response to a selection via the user interface 1600 of the export option, the yard check engine 205 may generate a datasheet that includes entries for each tracked cargo order and that includes all of the generated tracked cargo data for each order.

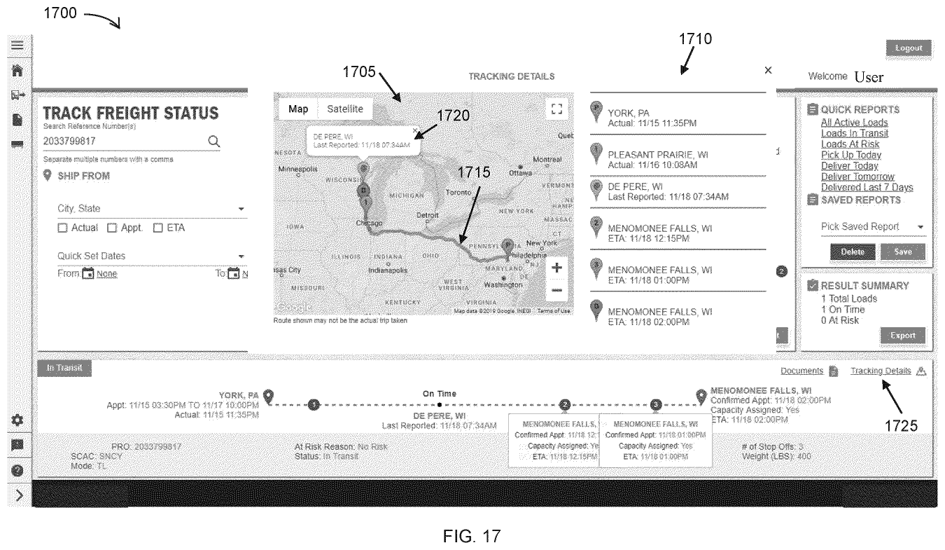

Turning now to FIG. 17, a user interface 1700 of the yard check application 200 is shown, in accordance with some embodiments of the present disclosure. In some embodiments, the yard check engine 205 generates the user interface 1700 in response to user activation of the selectable tracking details link 1725. In some embodiments, upon activation of the tracking details link 1725 on the user interface 1600, a tracking details window 1710 is displayed as a pop-up window. The tracking details window 1710 may include an interactive map 1705 and/or a delivery route stop list. In some embodiments, the delivery route stop list shows the stop name, city/state of the stop location, and arrival time at the stop location for each stop-off on the delivery route for the tracked cargo order. The arrival time at each stop location may be an estimated time of arrival if that stop location has yet to be reached, or an actual time of arrival if that stop location has been reached and departed from on the delivery route. The arrival time may include the date of arrival and the time of arrival for each stop location on the delivery route. In some embodiments, the interactive map 1705 shows the delivery route for the tracked cargo order and markers for each stop on the delivery route. In response to receiving a user selection of one of the trackers at a stop location and/or a cursor hovering over a tracker for a stop, the yard check engine 205 may generate and display a location summary window 1720 for that stop location. The location summary window 1720 may include the same or similar information as displayed for that stop location in the delivery route stop location list of the tracking details window 1710. For example, the location summary window may include the city/state of the stop location and the predicted, last reported, or actual arrival time at the stop location.

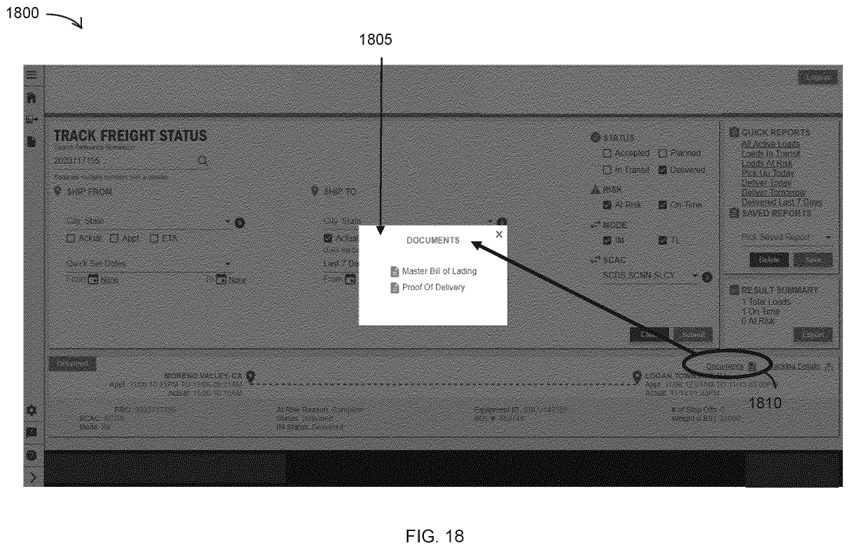

Turning now to FIG. 18, a user interface 1800 of the yard check application 200 is shown, in accordance with some embodiments of the present disclosure. The user interface 1800 includes a documents display window 1805 and a selectable documents link 1810. In some embodiments, in response to user activation of the documents link 1810 (also shown on the user interface 1600), the yard check engine 205 generates and displays the user interface 1800. The documents display window 1805 may include links to a Master Bill of Lading document and a Proof of Delivery document, for example. In some embodiments, upon selection via the user interface 1800 of one of the documents in the documents display window 1805, the yard check engine 205 may export and/or save the document to memory storage designated by the user. As such, the yard check application 200 allows a user to quickly access shipment documents for any individual shipping order while tracking the current shipping orders.

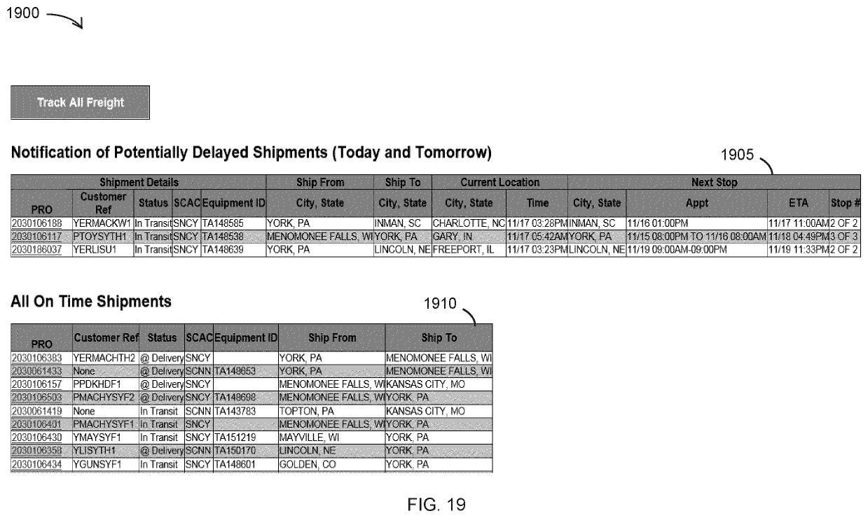

Referring now to FIG. 19, an example view 1900 of an email push notification is shown, in accordance with some embodiments of the present disclosure. In some embodiments, the email push notification is automatically generated by the yard check engine 205 on a user defined frequency. For example, the yard check engine 205 may generate and send corresponding customer email addresses the email push notification a certain amount of times per day, seven days per week. In other embodiments, a user may modify the frequency of the email push notification in customer settings of the yard check application 200. In some embodiments, the email push notification includes a potentially delayed shipments table 1905 and an on time shipments table 1910. In some embodiments, the potentially delayed shipments table 1905 includes tracking data for shipments that are determined by the yard check engine 205 as being potentially delayed for shipments that were supposed to be delivered that day and the day after the email push notification sent date. In some embodiments, the email push notification generated by the yard check engine 205 includes dynamic links that directly connect a user to a customer visibility site to view load tracking details. In some embodiments, the yard check engine 205 creates a dynamic link for tracking all cargo and includes the dynamic link in the generated email push notification. As such, a user may be able to select a link to “Track All Freight” in order to view all tracked loads in the yard check application 200.

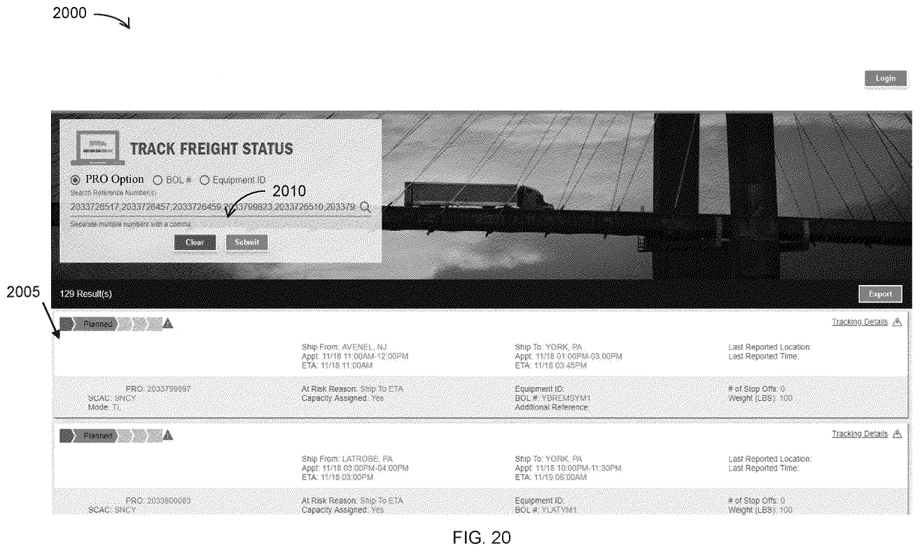

Turning now to FIG. 20, a user interface 2000 of the yard check application 200 is shown, in accordance with some embodiments of the present disclosure. In some embodiments, the user interface 2000 is generated and presented by the yard check engine 205 to provide users the ability to anonymously track shipping orders and to quickly access tracking information through the dynamic link provided in the generated email push notification (shown in FIG. 19). In some embodiments, the current tracking location of shipment orders can be presented in the user interface 2000 in card view or in a map view. In some embodiments, login information can be received by the yard check engine 205 in order to sign in the user and present more detailed tracking data on the load orders of the user. Beneficially, the email push notification generated by the yard check engine 205 and the user interface 2000 allow users to connect to “anonymous tracking.” As such, the user may not be required to login in order to view a portion of the tracked information on the respective order(s). The user interface 2000 includes input options 2010 to submit reference numbers to search for a specific order. The user interface 2000 may also include tracked order results 2005. In some embodiments, the yard check engine 205 generates and lists the tracked order results 2005 based on which order has the earliest shipment time. Each of the tracked order results 2005 may display tracked shipment information. For example, the tracked order results 2005 may include various tracked cargo data, such as the shipment departure location, shipment delivery location, estimated time of arrivals at each stop on the delivery route, and so on.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving sensor data from a trailer;
determining a current status of the trailer based on the sensor data, wherein the current status comprises a location of the trailer and whether the trailer is empty or loaded;
updating the current status of the trailer based upon at least one of an order information or user input; and
making the updated status of the trailer available to a user via a user interface.

2. The method of claim 1, further comprising displaying the trailer on an interactive map of the user interface indicating a current location of the trailer.

3. The method of claim 1, wherein updating the current status based on the order information comprises:
comparing the order information against the current status to identify a discrepancy between the order information and the current status; and
updating the current status of the trailer with a status identified from the order information.

4. The method of claim 1, wherein updating the current status based on the user input comprises:
comparing the current status with the user input to identify a discrepancy between the current status and the user input; and
updating the current status with a status identified from the user input.

5. The method of claim 1, wherein determining the location of the trailer comprises determining whether the trailer is located on a yard or en-route.

6. The method of claim 5, wherein determining whether the trailer is located on the yard or en-route is based upon at least one of location data from the sensor data or a geo-fence associated with the yard.

7. The method of claim 5, further comprising, upon detecting that the trailer is located on the yard, identifying an area of the yard where the trailer is located.

8. The method of claim 5, wherein determining that the trailer is en-route further comprises determining whether the trailer is inbound or outbound.

9. The method of claim 1, further comprising determining that the trailer is empty or loaded by comparing image data from an inside of the trailer to a baseline image.

10. The method of claim 1, further comprising, upon determining that the trailer is loaded, determining a type of cargo that is loaded into the trailer by comparing image data from an inside of the trailer to image data in a baseline image.

11. The method of claim 1, wherein the trailer is part of a plurality of trailers, and wherein the method further comprises:
determining the current status of each of the plurality of trailers;
displaying a location of each of the plurality of trailers on a map on the user interface; and
providing a summary of the current status of each of the plurality of trailers on the user interface.

12. The method of claim 11, further comprising:
receiving another user input for filtering the plurality of trailers; and
displaying the plurality of trailers on the map that satisfy the another user input.

13. A system, comprising:
one or more memories having computer-readable instructions stored thereon; and
one or more processors that execute the computer-readable instructions to:
receive sensor data from a trailer;
determine a current status of the trailer based on the sensor data, wherein the current status comprises a location of the trailer and whether the trailer is empty or loaded;
update the current status of the trailer based upon at least one of an order information or user input; and
make the updated status of the trailer available to a user via a user interface.

14. The system of claim 13, wherein to update the current status based on the order information and the user input, the one or more processors further execute the computer-readable instructions to:
update the current status to a first updated status upon identifying a discrepancy between the order information and the current status; and
update the first updated status to a second updated status upon identifying a discrepancy between the first updated status and the user input.

15. The system of claim 13, wherein to update the current status based on the order information and the user input, the one or more processors further execute the computer-readable instructions to:
update the current status to a first updated status upon identifying a discrepancy between the current status and the user input; and
update the first updated status to a second updated status upon identifying a discrepancy between the first updated status and the order information.

16. The system of claim 13, wherein the trailer is part of a plurality of trailers, and wherein the one or more processors further execute the computer-readable instructions to:
determine the current status of each of the plurality of trailers;
display a location of each of the plurality of trailers on a map on the user interface; and
provide a summary of the current status of each of the plurality of trailers on the user interface.

17. The system of claim 18, wherein the one or more processors further execute the computer-readable instructions to:
receive another user input for filtering the plurality of trailers; and
display the plurality of trailers on the map that satisfy the another user input.

18. One or more non-transitory computer-readable storage media comprising computer-readable instructions stored thereon that when executed by a processor of a yard check application cause the processor to:
receive sensor data from a trailer;
determine a current status of the trailer based on the sensor data, wherein the current status comprises a location of the trailer and whether the trailer is empty or loaded;
update the current status of the trailer based upon at least one of an order information or user input; and
make the updated status of the trailer available to a user via a user interface.

19. The one or more non-transitory computer-readable storage media of claim 18, wherein determining the location of the trailer comprises determining whether the trailer is located on a yard or en-route.

20. The one or more non-transitory computer-readable storage media of claim 19, wherein determining that the trailer is en-route further comprises determining whether the trailer is inbound or outbound.
